(19) United States
(12) Patent Application Publication
(10) Pub. No.: US 2009/0017298 A1
(43) Pub. Date: Jan. 15, 2009

(54) Adhesive composition, adhesive optical film and image display device

(75) Inventors: Kenichi Okada, Osaka (JP); Toshitaka Takahashi, Osaka (JP); Mika Okada, Osaka (JP); Hitoshi Takahira, Osaka (JP); Kuniaki Inui, Osaka (JP)

Correspondence Address: AKERMAN SENTERFITT, 801 PENNSYLVANIA AVENUE N.W., SUITE 600, WASHINGTON, DC, 20004, US

(73) Assignee: Nitto Denko Corporation, Osaka (JP)

(21) Appl. No.: 12/216,792

(22) Filed: Jul. 10, 2008

(30) Foreign Application Priority Data
Jul. 11, 2007 (JP) 2007-182403
May 22, 2008 (JP) 2008-133830

(51) Int. Cl. B32B 33/00; C08K 3/34

(52) U.S. Cl. 428/354; 524/445; 524/140; 524/284

(57) ABSTRACT

An adhesive composition contains a copolymer obtained by preparing a monomer component containing an alkyl(meth)acrylate whose alkyl group has 4 to 18 carbon atoms, a carboxyl group-containing vinyl monomer and a phosphoric acid group-containing vinyl monomer as essential components, and containing, as an optional component, a copolymerizable vinyl monomer which is copolymerizable with the essential components so that an amount of the alkyl(meth)acrylate is from 60 to 99 parts by weight per 100 parts by weight of the monomer component, a total amount of the carboxyl group-containing vinyl monomer, the phosphoric acid group-containing vinyl monomer and the copolymerizable vinyl monomer is from 1 to 40 parts by weight per 100 parts by weight of the monomer component and polymerizing the monomer component; and a clay mineral so that an amount of the clay mineral is from 0.5 to 10 parts by weight per 100 parts by weight of the copolymer.

### CROSS REFERENCE TO RELATED APPLICATION

This application claims priorities from Japanese Patent Application Nos. 2008-133830, filed May 22, 2008 and 2007-182403, filed Jul. 11, 2007, the contents of which are herein incorporated by reference in their entirety.

### BACKGROUND OF THE INVENTION

1. Field of the Invention

The present invention relates to an adhesive composition, an adhesive optical film and an image display device.

2. Description of Related Art

Optical films such as polarizing film, phase difference film, luminance improving film and view-angle expansion film have been conventionally used in various industrial applications and, for example, these optical films are used for sticking onto image display devices such as liquid crystal display, organic electroluminescence device (organic EL display device) and plasma display panel (PDP).

As such optical film, an adhesive optical film is known that includes an optical film laminated with an adhesive. Solvent type adhesives using an organic solvent as a solvent are usually used in the adhesive optical film.

On the other hand, from the viewpoint of environmental burden, it is desirable in recent years to reduce the use of organic solvents, and shifting is desired from solvent type adhesives to aqueous dispersion type adhesives using water as a dispersion medium.

As such aqueous dispersion type adhesives, for example, there has been proposed a pressure-sensitive adhesive composition having a copolymer emulsion in which 2-ethylhexyl methacrylate is copolymerized in an amount from 10 to 50% by weight of the whole copolymer, the copolymer having a glass transition temperature of −25° C. or less (cf. for example, Japanese Unexamined Patent Publication No. 2001-254063).

Conventional aqueous dispersion adhesives including those disclosed in Japanese Unexamined Patent Publication No. 2001-254063 mentioned above disadvantageously show particularly low adhesion to a hydrophilic adherend such as glass, although adhesion to a hydrophobic adherend such as polyolefin is improved. It has therefore difficulty to firmly stick to a glass substrate of an image display device or the like.

As an aqueous dispersion adhesive having transparency and applicable to glass, there has been proposed an aqueous dispersion type acrylic adhesive composition obtained by mixing an aqueous dispersion of an acrylic copolymer obtained by emulsion polymerization of butyl acrylate, acrylic acid and 3-methacryloyl oxypropyl trimethoxysilane with an aqueous dispersion of a smectite layered clay mineral (cf. for example, Japanese Unexamined Patent Publication No. 2006-316085).

### SUMMARY OF THE INVENTION

The aqueous-dispersion-type acrylic adhesive composition described in Japanese Unexamined Patent Publication No. 2006-316085 can ensure adhesion to glass. However, it has a limitation to be applied to optical films because of its slightly low adhesion (heat-resistant adhesion) under a high temperature atmosphere.

It is an object of the present invention to provide an adhesive composition having excellent adhesion with an optical film, heat resistance and moisture resistance and excellent transparency, an adhesive optical film including an adhesive layer made of the adhesive composition, and an image display device using the adhesive optical film.

The adhesive composition of the present invention includes a copolymer obtained by preparing a monomer component comprising an alkyl(meth)acrylate whose alkyl group has 4 to 18 carbon atoms, a carboxyl group-containing vinyl monomer and a phosphoric acid group-containing vinyl monomer as essential components, and including, as an optional component, a copolymerizable vinyl monomer which is copolymerizable with the essential components so that an amount of the alkyl(meth)acrylate is from 60 to 99 parts by weight per 100 parts by weight of the monomer component, a total amount of the carboxyl group-containing vinyl monomer, the phosphoric acid group-containing vinyl monomer and the copolymerizable vinyl monomer is from 1 to 40 parts by weight per 100 parts by weight of the monomer component, a carboxyl group concentration is from 0.05 to 1.50 mmol/g and a phosphoric acid group concentration is from 0.01 to 0.45 mmol/g in the monomer component, and polymerizing the monomer component; and a clay mineral, so that an amount of the clay mineral is from 0.5 to 10 parts by weight per 100 parts by weight of the copolymer.

Further, it is preferable that the adhesive composition of the present invention further includes a phosphate dispersing agent in an amount from 0.1 to 5 parts by weight and/or a polycarboxylate dispersing agent in an amount from 0.1 to 5 parts by weight per 100 parts by weight of the copolymer.

Further, in the adhesive composition of the present invention, it is preferable that an amount of the carboxyl group-containing vinyl monomer is from 0.5 to 15 parts by weight, an amount of the phosphoric acid group-containing vinyl monomer is from 0.5 to 20 parts by weight, and an amount of the copolymerizable vinyl monomer is 39 parts by weight or less per 100 parts by weight of the monomer component.

Further, it is preferable that the adhesive composition of the present invention includes, as the copolymerizable vinyl monomer, an alkoxysilyl group-containing vinyl monomer in an amount from 0.001 to 1 part by weight per 100 parts by weight of the monomer component.

Further, it is preferable that the adhesive composition of the present invention is an aqueous dispersion.

Further, in the adhesive composition of the present invention, it is preferable that the clay mineral is a smectite.

Further, in the adhesive composition of the present invention, it is preferable that the clay mineral includes an organized clay mineral.

Further, in the adhesive composition of the present invention, it is preferable that the organized clay mineral is organized by an organic cation having a hydrophilic functional group.

Further, in the adhesive composition of the present invention, it is preferable that the organic cation having the hydrophilic functional group is a quaternary ammonium salt having a hydroxyl group.

Further, it is preferable that the adhesive composition of the present invention is obtained by mixing an aqueous dispersion which is obtained by dispersing the clay mineral in water, and an aqueous dispersion of the copolymer in water having the phosphate dispersing agent and/or the polycarboxylate dispersing agent mixed therein.

Further, the adhesive optical film of the present invention includes an optical film; an adhesive layer laminated on at least one side of the optical film; and an undercoat layer interposed between the optical film and the adhesive layer, the adhesive layer is made of an adhesive composition including a copolymer obtained by preparing a monomer component comprising an alkyl(meth)acrylate whose alkyl group has 4 to 18 carbon atoms, a carboxyl group-containing vinyl monomer and a phosphoric acid group-containing vinyl monomer as essential components, and including, as an optional component, a copolymerizable vinyl monomer which is copolymerizable with the essential components so that an amount of the alkyl(meth)acrylate is from 60 to 99 parts by weight per 100 parts by weight of the monomer component, a total amount of the carboxyl group-containing vinyl monomer, the phosphoric acid group-containing vinyl monomer and the copolymerizable vinyl monomer is from 1 to 40 parts by weight per 100 parts by weight of the monomer component, a carboxyl group concentration is from 0.05 to 1.50 mmol/g and a phosphoric acid group concentration is from 0.01 to 0.45 mmol/g in the monomer component, and polymerizing the monomer component; and a clay mineral so that an amount of the clay mineral is from 0.5 to 10 parts by weight per 100 parts by weight of the copolymer.

Further, in the adhesive optical film of the present invention, it is preferable that the undercoat layer includes an oxazoline group-containing polymer.

Further, in the adhesive optical film of the present invention, it is preferable that the undercoat layer includes a water-soluble or aqueous dispersion electrically conductive material.

Further, in the adhesive optical film of the present invention, it is preferable that the undercoat layer includes a mixture of an oxazoline group-containing polymer and a compound having a plurality of carboxyl groups.

Further, in the adhesive optical film of the present invention, it is preferable that the undercoat layer includes a mixture of an oxazoline group-containing polymer and a water-soluble or aqueous dispersion electrically conductive material.

Further, in the adhesive optical film of the present invention, it is preferable that the undercoat layer includes a mixture of an oxazoline group-containing polymer and a polyamine polymer.

Further, in the adhesive optical film of the present invention, it is preferable that the undercoat layer includes a mixture of an oxazoline group-containing polymer, a compound having a plurality of carboxyl groups and a water-soluble or aqueous dispersion electrically conductive material.

Further, in the adhesive optical film of the present invention, it is preferable that the water-soluble or aqueous dispersion electrically conductive material is an electrically conductive polymer.

Further, in the adhesive optical film of the present invention, it is preferable that the electrically conductive polymer is polyaniline and/or polythiophene.

Further, in the adhesive optical film of the present invention, it is preferable that the water-soluble or aqueous dispersion electrically conductive material is an organometallic compound.

Further, in the adhesive optical film of the present invention, it is preferable that the organometallic compound is at least one compound selected from the group consisting of an organic zirconium compound, an organic titanium compound and an organic aluminium compound.

The image display device of the present invention uses at least one adhesive optical film including an optical film; an adhesive layer laminated on at least one side of the optical film; and an undercoat layer interposed between the optical film and the adhesive layer, the adhesive layer is made of an adhesive composition including a copolymer obtained by preparing a monomer component including an alkyl(meth)acrylate whose alkyl group has 4 to 18 carbon atoms, a carboxyl group-containing vinyl monomer and a phosphoric acid group-containing vinyl monomer as essential components, and comprising, as an optional component, a copolymerizable vinyl monomer which is copolymerizable with the essential components so that an amount of the alkyl(meth)acrylate is from 60 to 99 parts by weight per 100 parts by weight of the monomer component, a total amount of the carboxyl group-containing vinyl monomer, the phosphoric acid group-containing vinyl monomer and the copolymerizable vinyl monomer is from 1 to 40 parts by weight per 100 parts by weight of the monomer component, a carboxyl group concentration is from 0.05 to 1.50 mmol/g and a phosphoric acid group concentration is from 0.01 to 0.45 mmol/g in the monomer component, and polymerizing the monomer component; and a clay mineral so that an amount of the clay mineral is from 0.5 to 10 parts by weight per 100 parts by weight of the copolymer.

The adhesive layer formed of the adhesive composition of the present invention shows excellent adhesion with an optical film. Therefore, in the adhesive optical film of the present invention including such adhesive layer, firm adhesion between the optical film and a substrate can be achieved.

The adhesive optical film of the present invention is excellent in transparency. Further, the adhesive optical film has excellent heat resistance and moisture resistance, so that excellent adhesion to a substrate under a high temperature and high humidity atmosphere can be obtained.

Therefore, the image display device of the present invention using the adhesive optical film of the present invention can acquire good appearance, and can also achieve excellent heat resistance and moisture resistance.

### BRIEF DESCRIPTION OF THE DRAWINGS

FIG. 1 is an enlarged sectional view of one embodiment of an adhesive optical film according to the present invention.

### DETAILED DESCRIPTION OF PREFERRED EMBODIMENTS

The adhesive composition of the present invention contains a copolymer obtained by preparing a monomer component and polymerizing it, and a clay mineral.

The monomer component contains an alkyl(meth)acrylate, a carboxyl group-containing vinyl monomer and a phosphoric acid group-containing vinyl monomer as essential components, and contains, as an optional component, a copolymerizable vinyl monomer which is copolymerizable with the essential components.

The alkyl(meth)acrylate is, for example, an alkyl(meth)acrylate (an alkyl methacrylate and/or an alkyl acrylate) whose linear or branched alkyl group has 1 to 18 carbon atoms, or preferably an alkyl(meth)acrylate whose linear or branched alkyl group has 4 to 18 carbon atoms. Examples of the alkyl(meth)acrylate whose alkyl group has 4 to 18 carbon atoms include butyl(meth)acrylate, isobutyl(meth)acrylate, sec-butyl(meth)acrylate, t-butyl(meth)acrylate, pentyl (meth)acrylate, neopentyl(meth)acrylate, isoamyl (meth)acrylate, hexyl(meth)acrylate, heptyl(meth)acrylate, octyl(meth)acrylate, 2-ethylhexyl(meth)acrylate, isooctyl (meth)acrylate, nonyl(meth)acrylate, isononyl(meth)acrylate, decyl(meth)acrylate, isodecyl(meth)acrylate, undecyl (meth)acrylate, dodecyl(meth)acrylate, tridecyl (meth)acrylate, tetradecyl(meth)acrylate, pentadecyl (meth)acrylate, hexadecyl(meth)acrylate, heptadecyl (meth)acrylate and octadecyl(meth)acrylate. Butyl acrylate is preferable. These alkyl(meth)acrylates can be used alone or in combination of two or more kinds.

The amount of the alkyl(meth)acrylate is from 60 to 99 parts by weight, preferably from 70 to 99 parts by weight, or more preferably from 80 to 99 parts by weight per 100 parts by weight of the monomer component.

The carboxyl group-containing vinyl monomer is a vinyl monomer to improve adhesion of an adhesive layer (described later) with respect to a substrate by introducing a crosslinking point (carboxyl group) to be thermally crosslinked, and having a carboxyl group in the molecule. Examples thereof include unsaturated carboxylic acids such as (meth)acrylic acid, fumaric acid, maleic acid, itaconic acid, crotonic acid and cinnamic acid; unsaturated dicarboxylic acid monoesters such as monomethyl itaconate, monobutyl itaconate and 2-acryloyloxyethylphthalic acid; unsaturated tricarboxylic acid monoesters such as 2-methacryloyloxyethyltrimellitic acid and 2-methacryloyloxyethylpyromellitic acid; and carboxyalkyl acrylates such as carboxyethyl acrylate (β-carboxyethyl acrylate, etc.), carboxypentyl acrylate.

In addition, examples of the carboxyl group-containing vinyl monomer also include unsaturated dicarboxylic acid anhydrides such as itaconic anhydride, maleic anhydride and fumaric anhydride.

These carboxyl group-containing vinyl monomers can be used alone or in combination of two or more kinds.

Among these carboxyl group-containing vinyl monomers, acrylic acid or carboxyethyl acrylate is preferable.

The carboxyl group concentration of the carboxyl group-containing vinyl monomer in the monomer component is from 0.05 to 1.50 mmol/g, or preferably from 0.20 to 0.90 mmol/g. To adjust the carboxyl group concentration of the carboxyl group-containing vinyl monomer within the above range, the amount of the carboxyl group-containing vinyl monomer is set, for example, from 0.4 to 41 parts by weight, or preferably from 1.4 to 25 parts by weight per 100 parts by weight of the monomer component, although it depends on the molecular weight of the carboxyl group-containing vinyl monomer. The amount of the carboxyl group-containing vinyl monomer can also be set, for example, from 0.5 to 15 parts by weight, or preferably from 0.5 to 10 parts by weight per 100 parts by weight of the monomer component within the above carboxyl group concentration. When the amount is less than the above range, stability upon polymerization and cohesive force of the adhesive composition may decrease. On the other hand, when the amount is more than the above range, water resistance of the adhesive composition may deteriorate.

The carboxyl group concentration of the carboxyl group-containing vinyl monomer is calculated by the following equation:

Carboxyl group concentration [mmol/g]=1000×{(mixing weight [g] of carboxyl group-containing vinyl monomer)/(molecular weight [g/mol] of carboxyl group-containing vinyl monomer)}/(weight [g] of monomer component)

Since the monomer component contains such carboxyl group-containing vinyl monomer, when an undercoat layer contains an oxazoline group-containing polymer and a polyamine polymer, the carboxyl group-containing vinyl monomer efficiently reacts with an oxazoline group and an amino group thereof, so that adhesion between an adhesive layer and an optical film can be improved.

The phosphoric acid group-containing vinyl monomer is, for example, a polyalkylene oxide (meth)acrylate phosphate ester represented by the following general formula (1):

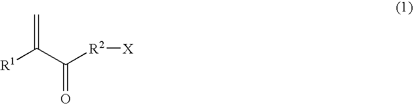

in the general formula (1), R¹ represents a hydrogen atom or a methyl group, R² represents a polyoxyalkylene group, and X represents a phosphoric acid group or a salt thereof.

The polyoxyalkylene group represented by R² is represented by the following general formula (2):

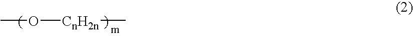

in the general formula (2), n represents an integer of 1 to 4, and m represents an integer of 2 or more.

Examples thereof include polyoxyethylene group (corresponding to n=2 in the general formula (2)), polyoxypropylene group (corresponding to n=3 in the general formula (2)) and a random, block, or graft unit thereof. The degree of polymerization of these oxyalkylene groups, namely m in the general formula (2), is preferably 4 or more, and usually 40 or less.

The phosphoric acid group or a salt thereof represented by X is represented by the following general formula (3):

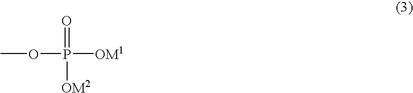

in the general formula (3), M¹ and M² each independently represents a hydrogen atom or a cation.

The cation is not particularly limited, and examples thereof include inorganic cations of alkali metals such as sodium and potassium, and alkaline earth metals such as calcium and magnesium; and organic cations of quaternary amines.

As the phosphoric acid group-containing vinyl monomer, commercially available products can be used, and examples thereof include mono[poly(ethylene oxide)methacrylate]phosphate esters such as Sipomer PAM-100 (manufactured by Rhodia Nicca, Ltd.), Phosmer PE (manufactured by Uni-Chemical Co., Ltd.), Phosmer PEH (manufactured by Uni-Chemical Co., Ltd.) and Phosmer PEDM (manufactured by Uni-Chemical Co., Ltd.); and mono[poly(propylene oxide)methacrylate]phosphate esters such as Sipomer PAM-200 (manufactured by Rhodia Nicca, Ltd.), Phosmer PP (manufactured by Uni-Chemical Co., Ltd.), Phosmer PPH (manufactured by Uni-Chemical Co., Ltd.) and Phosmer PPDM (manufactured by Uni-Chemical Co., Ltd.).

These phosphoric acid group-containing vinyl monomers can be used alone or in combination of two or more kinds.

The phosphoric acid group concentration of the phosphoric acid group-containing vinyl monomer in the monomer component is from 0.01 to 0.45 mmol/g, or preferably from 0.02 to 0.20 mmol/g. To adjust the phosphoric acid group concentration of the phosphoric acid group-containing vinyl monomer within the above range, the amount of the phosphoric acid group-containing vinyl monomer is set, for example, from 0.4 to 22 parts by weight, or preferably from 0.8 to 10 parts by weight per 100 parts by weight of the monomer component, although it depends on the molecular weight of the phosphoric acid group-containing vinyl monomer. The amount of the phosphoric acid group-containing vinyl monomer can also be set, for example, from 0.5 to 20 parts by weight, or preferably from 0.5 to 10 parts by weight per 100 parts by weight of the monomer component within the above phosphoric acid group concentration. When the amount is less than the above range, heat-resistant adhesion (adhesion under a high temperature atmosphere) may deteriorate. On the other hand, when the amount is more than the above range, stability upon polymerization may decrease, or adhesion may deteriorate due to excessively increased elastic modulus of the adhesive composition.

The phosphoric acid group concentration of the phosphoric acid group-containing vinyl monomer is calculated by the following equation:

Phosphoric acid group concentration [mmol/g]=1000×{(mixing weight [g] of phosphoric acid group-containing vinyl monomer)/(molecular weight [g/mol] of phosphoric acid group-containing vinyl monomer)}/(weight [g] of monomer component)

Examples of the copolymerizable vinyl monomer include functional group-containing vinyl monomers other than carboxyl group-containing vinyl monomers.

Examples of the functional group-containing vinyl monomer include vinyl carboxylate esters such as vinyl acetate and vinyl propionate; hydroxyl group-containing vinyl monomers such as 2-hydroxyethyl acrylate, 2-hydroxypropyl acrylate and 2-hydroxybutyl acrylate; amide group-containing unsaturated monomers such as (meth)acrylamide, N,N-dimethyl (meth)acrylamide, N,N-diethyl(meth)acrylamide, N-isopropyl (meth)acrylamide, N-butyl(meth)acrylamide, N-methoxymethyl (meth)acrylamide, N-methylol (meth)acrylamide, N-methylolpropane (meth)acrylamide and N-vinylcarboxylic acid amide; amino group-containing unsaturated monomers such as aminoethyl(meth)acrylate, N,N-dimethylaminoethyl (meth)acrylate, and t-butylaminoethyl(meth)acrylate; glycidyl group-containing unsaturated monomers such as glycidyl(meth)acrylate and methyl glycidyl(meth)acrylate; cyano group-containing unsaturated monomers such as acrylonitrile and methacrylonitrile; isocyanate group-containing unsaturated monomers such as 2-methacryloiloxyethyl isocyanate; sulfonic acid group-containing unsaturated monomers such as styrenesulfonic acid, allylsulfonic acid, 2-(meth)acrylamide-2-methylpropanesulfonic acid, (meth)acrylamidepropanesulfonic acid, sulfopropyl (meth)acrylate and (meth)acryloyloxynaphthalenesulfonic acid; maleimide-based monomers such as N-cyclohexylmaleimide, N-isopropylmaleimide, N-laurylmaleimide and N-phenylmaleimide; itaconimide-based monomers such as N-methylitaconimide, N-ethylitaconimide, N-butylitaconimide, N-octylitaconimide, N-2-ethylhexylitaconimide, N-cyclohexylitaconimide and N-laurylitaconimide; succinimide-based monomers such as N-(meth)acryloyloxymethylenesuccinimide, N-(meth)acryloyl-6-oxyhexamethylenesuccinimide and N-(meth)acryloyl-8-oxyoctamethylenesuccinimide; and glycol-based acryl ester monomers such as (meth)acrylic acid polyethylene glycol, (meth)acrylic acid polypropylene glycol, (meth)acrylic acid methoxyethylene glycol and (meth)acrylic acid methoxypolypropylene glycol.

Examples of the functional group-containing vinyl monomer mentioned above further include polyfunctional monomers.

Examples of the polyfunctional monomer include (mono or poly)alkylene glycol di(meth)acrylates, for example, (mono or poly)ethylene glycol di(meth)acrylates such as ethylene glycol di(meth)acrylate, diethylene glycol di(meth)acrylate, triethylene glycol di(meth)acrylate, trimethylolpropane tri(meth)acrylate and tetraethylene glycol di(meth)acrylate, and (mono or poly)propylene glycol di(meth)acrylates such as propylene glycol di(meth)acrylate; (meth)acrylate monomers of polyhydric alcohol such as neopentyl glycol di(meth)acrylate, 1,6-hexandiol di(meth)acrylate, pentaerythritol, di(meth)acrylate, trimethylolpropane tri(meth)acrylate, pentaerythritol tri(meth)acrylate and dipentaerythritol hexa(meth)acrylate; and divinyl benzene. Examples of the polyfunctional monomer also include epoxy acrylate, polyester acrylate and urethane acrylate.

Examples of the copolymerizable vinyl monomer include, in addition to the functional group-containing vinyl monomers mentioned above, aromatic vinyl monomers such as styrene and vinyltoluene; (meth)acrylic acid alicyclic hydrocarbon esters such as cyclopentyl di(meth)acrylate, cyclohexyl(meth)acrylate, bornyl(meth)acrylate and isobornyl(meth)acrylate; aryl(meth)acrylate esters such as phenyl(meth)acrylate; alkoxy group-containing unsaturated monomers such as methoxyethyl(meth)acrylate and ethoxyethyl(meth)acrylate; olefin-based monomers such as ethylene, propylene, isoprene, butadiene and isobutylene; vinyl ether-based monomers such as vinyl ether; halogen atom-containing unsaturated monomers such as vinyl chloride; vinyl group-containing heterocyclic compounds such as N-vinyl pyrrolidone, N-(1-methylvinyl)pyrrolidone, N-vinylpyridine, N-vinylpiperidone, N-vinylpyrimidine, N-vinylpiperazine, N-vinyl pyrazine, N-vinylpyrrole, N-vinylimidazole, N-vinyloxazol, N-vinylmorpholine, and tetrahydrofurfuryl (meth)acrylate; and acrylate ester-based monomers containing a halogen atom such as fluorine atom, such as fluorine (meth)acrylate.

Examples of the copolymerizable vinyl monomer further include alkoxysilyl group-containing vinyl monomer. Examples of the alkoxysilyl group-containing vinyl monomer include silicone (meth)acrylate monomer and silicone vinyl monomer.

Examples of the silicone (meth)acrylate monomer include (meth)acryloyloxyalkyl-trialkoxysilanes such as (meth)acryloyloxymethyl-trimethoxysilane, (meth)acryloyloxymethyl-triethoxysilane, 2-(meth)acryloyloxyethyl-trimethoxysilane, 2-(meth)acryloyloxyethyl-triethoxysilane, 3-(meth)acryloyloxypropyl-trimethoxysilane, 3-(meth)acryloyloxypropyl-triethoxysilane, 3-(meth)acryloyloxypropyl-tripropoxysilane, 3-(meth)acryloyloxypropyl-triisopropoxysilane and 3-(meth)acryloyloxypropyl-tributoxysilane; (meth)acryloyloxyalkyl-alkyldialkoxysilane such as (meth)acryloyloxymethyl-methyldimethoxysilane, (meth)acryloyloxymethyl-methyldiethoxysilane, 2-(meth)acryloyloxyethyl-methyldimethoxysilane, 2-(meth)acryloyloxyethyl-methyldiethoxysilane, 3-(meth)acryloyloxypropyl-methyldimethoxysilane, 3-(meth)acryloyloxypropyl-methyldiethoxysilane, 3-(meth)acryloyloxypropyl-methyldipropoxysilane, 3-(meth)acryloyloxypropyl-methyldiisopropoxysilane, 3-(meth)acryloyloxypropyl-methyldibutoxysilane, 3-(meth)acryloyloxypropyl-ethyldimethoxysilane, 3-(meth)acryloyloxypropyl-ethyldiethoxysilane, 3-(meth)acryloyloxypropyl-ethyldipropoxysilane, 3-(meth)acryloyloxypropyl-ethyldiisopropoxysilane, 3-(meth)acryloyloxypropyl-ethyldibutoxysilane, 3-(meth)acryloyloxypropyl-propyldimethoxysilane, 3-(meth)acryloyloxypropyl-propyldiethoxysilane; and (meth)acryloyloxyalkyl-dialkyl(mono)alkoxysilanes corresponding to these monomers.

Examples of the silicone vinyl monomer include vinyltrialkoxysilanes such as vinyltrimetoxysilane, vinyltriethoxysilane, vinyltripropoxysilane, vinyltriisopropoxysilane and vinyltributoxysilane, and vinylalkyldialkoxysilane and vinyldialkylalkoxysilane corresponding to these monomers; vinylalkyltrialkoxysilanes such as vinylmethyltrimetoxysilane, vinylmethyltriethoxysilane, β-vinylethyltrimethoxysilane, β-vinylethyltriethoxysilane, γ-vinylpropyltrimethoxysilane, γ-vinylpropyltriethoxysilane, γ-vinylpropyltripropoxysilane, γ-vinylpropyltriisopropoxysilane and γ-vinylpropyltributoxysilane, and (vinylalkyl)alkyldialkoxysilane and (vinylalkyl)dialkyl(mono)alkoxysilane corresponding to these monomers.

These copolymerizable vinyl monomers can be used alone or in combination of two or more kinds.

Among these copolymerizable vinyl monomers, alkoxysilyl group-containing vinyl monomer is preferable.

By using the alkoxysilyl group-containing vinyl monomer as the copolymerizable vinyl monomer, alkoxysilyl groups are introduced in the polymer chain and a crosslinked structure can be formed by the reaction therebetween. In particular, in an aqueous dispersion adhesive composition, the crosslinking agent described later does not form a uniform crosslinked structure, so that terminal peeling may be easily produced. However, the use of the alkoxysilyl group-containing monomer allows formation of a uniform crosslinked structure, so that adhesion and fixation to a substrate can be improved. Further, adhesion to a glass substrate can be enhanced by interaction between the alkoxysilyl groups and the glass substrate.

If necessary, the copolymerizable vinyl monomer is optionally mixed, and the amount thereof is, for example, 39 parts by weight or less, preferably 30 parts by weight or less, or more preferably 20 parts by weight or less per 100 parts by weight of the monomer component. When the copolymerizable vinyl monomer is a functional group-containing vinyl monomer, the amount thereof is, for example, from 0.5 to 12 parts by weight, or preferably from 1 to 8 parts by weight per 100 parts by weight of the monomer component. When the copolymerizable vinyl monomer is an alkoxysilyl group-containing vinyl monomer, the amount thereof is, for example, from 0.001 to 1 part by weight, or preferably from 0.01 to 0.1 parts by weight per 100 parts by weight of the monomer component. When the amount of the alkoxysilyl group-containing vinyl monomer is less than the above range, a cohesive force of the adhesive composition decreases and adhesion between the adhesive composition and the glass substrate cannot be improved because of poor crosslinking due to the alkoxysilyl group. On the other hand, when the amount thereof is more than the above range, stability upon polymerization and adhesion may deteriorate.

The total amount of the carboxyl group-containing vinyl monomer, the phosphoric acid group-containing vinyl monomer and the copolymerizable vinyl monomer among the above monomer components is from 1 to 40 parts by weight, or preferably from 1 to 30 parts by weight per 100 parts by weight of the monomer component.

To obtain the copolymer by polymerizing the monomer component, the monomer component prepared in the above mixing ratio is copolymerized by a polymerization method such as emulsion polymerization.

In the emulsion polymerization, together with the above monomer component, polymerization initiators, emulsifiers, and if necessary, chain transfer agents are mixed in water and then copolymerized. More specifically, a known emulsion polymerization method can be employed such as collective charging method (collective polymerization method), monomer dropping method and monomer emulsion dropping method. In the monomer dropping method, continuous dropping or divisional dropping is selected. Reaction conditions are selected, but the polymerization temperature is, for example, from 20 to 100° C.

The dissolved oxygen concentration in the monomer component solution can also be decreased by nitrogen substitution before, while, or after mixing of the polymerization initiator with the above monomer component.

The polymerization initiator is not particularly limited, and a polymerization initiator usually used in the emulsion polymerization is used. Examples thereof include azo-based initiators such as 2,2′-azobisisobutyronitrile, 2,2′-azobis(2-methylpropioneamidine) disulfate, 2,2′-azobis(2-methylpropioneamidine) dihydrochloride, 2,2′-azobis(2-amidinopropane) dihydrochloride, 2,2′-azobis[N-(2-carboxyethyl)-2-methylpropioneamidine]hydrate, 2,2′-azobis(N,N′-dimethyleneisobutylamidine) and 2,2′-azobis[2-(2-imidazolin-2-yl)propane]dihydrochloride; persulfate-based initiators such as potassium persulfate and ammonium persulfate; peroxide-based initiators such as benzoyl peroxide, t-butyl hydroperoxide and hydrogen peroxide; substituted ethane initiators such as phenyl substituted ethane; carbonyl initiators such as an aromatic carbonyl compound; and redox-based initiators such as combination of persulfate and sodium hydrogen sulfite and combination of peroxide and sodium ascorbate.

These polymerization initiators can be used alone or in combination of two or more kinds. Among these polymerization initiators, azo initiators are preferably used.

The amount of the polymerization initiator is selected and is, for example, from 0.05 to 1 part by weight per 100 parts by weight of the monomer component.

The emulsifier is not particularly limited and a known emulsifier usually used in the emulsion polymerization is used. Examples thereof include anionic emulsifiers such as sodium lauryl sulfate, ammonium lauryl sulfate, sodium dodecylbenzenesulfonate, polyoxyethylene sodium lauryl sulfate, sodium polyoxyethylene alkyl ether sulfate, ammonium polyoxyethylene alkyl phenyl ether sulfate, sodium polyoxyethylene alkyl phenyl ether sulfate and sodium polyoxyethylene alkyl sulfosuccinate; and nonionic emulsifiers such as polyoxyethylene alkyl ether, polyoxyethylene alkyl phenyl ether, polyoxyethylene fatty acid ester and polyoxyethylene polyoxypropylene block polymer.

The emulsifier further includes radical polymerizable (reactive) emulsifiers (e.g., HS-10 (manufactured by Dai-Ichi Kogyo Seiyaku Co., Ltd.)) in which a radical polymerizable functional group (reactive group) such as propenyl group or allyl ether group is introduced into the anionic emulsifier and the nonionic emulsifier.

These emulsifiers can be used alone or in combination of two or more kinds. The amount of the emulsifier is, for example, from 0.2 to 10 parts by weight, or preferably from 0.5 to 5 parts by weight per 100 parts by weight of the monomer component.

If necessary, the chain transfer agent is mixed to adjust a molecular weight of the copolymer, and a chain transfer agent used in the emulsion polymerization is used. Examples thereof include mercaptans such as 1-dodecanethiol, mercaptoacetic acid, 2-mercaptoethanol, 2-ethyl hexyl thioglycolate and 2,3-dimethylcapto-1-propanol.

These chain transfer agents can be used alone or in combination of two or more kinds. The amount of the chain transfer agent is, for example, from 0.001 to 0.5 parts by weight per 100 parts by weight of the monomer component.

The copolymer resulted from such emulsion polymerization can be prepared as an emulsion, namely an aqueous dispersion of the copolymer.

The aqueous dispersion of the copolymer can also be prepared, for example, by polymerizing the above monomer component through a method without using an organic solvent other than the emulsion polymerization method, and then dispersing the resulting polymer in water using the above emulsifier.

The gel fraction (gel fraction of the solid content in the emulsion) of the copolymer is, for example, from 50 to 100% by weight, or preferably from 70 to 100% by weight. When the gel fraction is less than the above range, foaming or peeling may be produced in the case where the aqueous dispersion adhesive composition made of an aqueous dispersion of the copolymer is applied to an adhesive optical film and the resulting product is used under a high temperature and high humidity atmosphere.

The clay mineral is, for example, smectite, namely, a montmorillonite group mineral, and examples thereof include phyllosilicate mineral having a layered structure. Examples of smectite include montmorillonite, magnesian montmorillonite, iron montmorillonite, iron magnesian montmorillonite, beidellite, aluminian beidellite, nontronite, aluminian nontronite, saponite, aluminian saponite, hectorite, sorconite and stevensite. These clay minerals can be used alone or in combination of two or more kinds.

The clay mineral is preferably organized, thereby having an organized portion. The organized portion is a portion in which cations in a crystal structure, that is, cations between layers are subjected to a hydrophobic (lipophilic) treatment with a cationic dispersing agent.

The cations in the clay mineral are exchangeable cations, and examples thereof include metallic cations such as sodium ions and calcium ions which exist on the surface of the crystal layer of a layered clay mineral.

Examples of the cationic dispersing agent include quaternary ammonium salts and quaternary phosphonium salts. Quaternary ammonium salts are preferable. Examples of the quaternary ammonium salt include salts of the cations in which a hydrogen atom of ammonium ion (NH⁴⁺) is substituted in a propylene oxide skeleton, an ethyleneoxide skeleton, an alkyl skeleton or the like, and salts of the anions such as halide ion (e.g., chloride ion). The cation preferably has a hydrophilic functional group such as hydroxyl group at its terminal. Specific examples of the cationic dispersing agent include a quaternary ammonium salt containing a propylene oxide skeleton having a hydroxyl group at its terminal. These cationic dispersing agents can be used alone or in combination of two or more kinds.

As the clay mineral having such organized portion, commercially available products are used, for example, Lucentite series (manufactured by CO-OP CHEMICAL CO., LTD.) are used, and specific examples thereof include Lucentite SPN, Lucentite SAN, Lucentite SEN and Lucentite STN.

The amount of the organized portion in the clay mineral is not particularly limited and is, for example, from 80 to 240 mol eq./100 g.

Since the cations of the clay mineral are usually hydrophilic, when the clay mineral has the organized (hydrophobic-treated) portion, hydrophobicity (lipophilicity) is imparted to interlayers of the clay mineral. Therefore, the clay mineral is prevented from swell and gelation in water, thereby ensuring that the clay mineral is dispersed in the emulsion.

The clay mineral has a thickness, for example, from 1 to 100 nm and a length (maximum length) of 500 nm or less, or preferably 100 nm or less. When the maximum length of the clay mineral exceeds the above range, the transparency may deteriorate.

The amount of the clay mineral (clay constituent, i.e., portion other than the organized portion in the clay mineral) is from 0.5 to 10 parts by weight, preferably from 1 to 8 parts by weight, or more preferably from 1 to 5 parts by weight per 100 parts by weight of the copolymer (i.e., solid content in the emulsion). When the amount of the clay mineral exceeds the above range, the transparency may deteriorate, failing to acquire good appearance. On the other hand, when the amount of the clay mineral is less than the above range, adhesion of the adhesive layer with respect to a substrate, particularly, adhesion under a high temperature and high humidity atmosphere cannot be improved.

The mixing of the clay mineral with the adhesive composition can improve adhesion of the adhesive layer with respect to a substrate, particularly, adhesion under a high temperature and high humidity atmosphere.

The adhesive composition of the present invention is prepared by mixing a copolymer and a clay mineral. For example, an aqueous dispersion of a clay mineral is prepared and the aqueous dispersion of the clay mineral thus prepared is then mixed with an aqueous dispersion of a copolymer.

The aqueous dispersion of the clay mineral is prepared, for example, by mixing a clay mineral with water or, if necessary, water in which a dispersing agent is mixed. Then, the clay mineral is dispersed in water using a dispersing apparatus.

The dispersing agent is mixed in order to efficiently disperse the clay mineral in water, and examples thereof include high molecular weight dispersing agents and low molecular weight dispersing agents. Low molecular weight dispersing agents are preferable. The low molecular weight dispersing agent is likely to enter an interspace between the aggregated (secondary aggregated) clay mineral particles, so that the clay mineral can be efficiently dispersed by crushing the particles. In addition, the low molecular weight dispersing agent is easily adsorbed onto the particles (primary particles) of the clay mineral, so that a repulsive force between the low molecular weight dispersing agents adsorbed on the particles can suppress the aggregation of the particles of the clay mineral.

Examples of the low molecular weight dispersing agent include anionic dispersing agents, or preferably phosphate dispersing agents and polycarboxylate dispersing agents.

The phosphate dispersing agent is, for example, a phosphate of metallic cations such as sodium and phosphoric acid, and specific examples thereof include sodium orthophosphate, sodium pyrophosphate (sodium diphosphate), sodium tripolyphosphate (sodium triphosphorate), sodium tetraphosphate, sodium hexametaphosphate, sodium polyphosphate, trisodium phosphate and sodium dihydrogenphosphate. Sodium hexametaphosphate is preferable. These phosphate dispersing agents can be used alone or in combination of two or more kinds.

The polycarboxylate dispersing agent is, for example, a polymer of carboxylate of inorganic cations (metallic cations) such as sodium or organic cations such as ammonium, and carboxylic acid, and specific examples thereof include sodium poly(meth)acrylate, ammonium poly(meth)acrylate, copolymers of sodium acrylate/sodium maleate and copolymers of ammonium acrylate/ammonium maleate. These polycalboxylate dispersing agent can be used alone or in combination of two or more kinds.

When the polycarboxylate dispersing agent is prepared in an aqueous dispersion or an aqueous solution, the content of the carboxyl anion is, for example, 4 to 10 mmol/g (weight of the polycarboxylate dispersing agent). The content of the carboxyl anion in the polycarboxylate dispersing agent is obtained by neutralization titration.

The polycarboxylate dispersing agent has a surface tension of 70 mN/m or more and usually 73 mN/m or less in a 1% aqueous solution at 20° C.

These dispersing agents can be used alone or in combination of two or more kinds.

The use of a phosphate dispersing agent and/or a polycarboxylate dispersing agent as a dispersing agent can prevent reaggregation of the clay mineral dispersed by a dispersing device.

In the case of using a phosphate dispersing agent as the dispersing agent, the amount of the dispersing agent is, for example, from 0.1 to 5 parts by weight, preferably from 0.3 to 3 parts by weight, more preferably from 0.4 to 2 parts by weight, or even more preferably from 0.5 to 2 parts by weight per 100 parts by weight of the copolymer (solid content in the emulsion). The amount of the phosphate dispersing agent can also be set, for example, from 1 to 200 parts by weight, preferably from 2 to 100 parts by weight, or more preferably from 3 to 50 parts by weight per 100 parts by weight of the clay mineral. When the amount of the phosphate dispersing agent exceeds the above range, dispersibility of the clay mineral may deteriorate. On the other hand, when the amount of the phosphate dispersing agent is less than the above range, dispersibility and stability may deteriorate, which may in turn generate aggregates.

In the case of using a polycarboxylate dispersing agent as the dispersing agent, the amount of the dispersing agent is, for example, from 0.1 to 5 parts by weight, preferably from 0.3 to 3 parts by weight, more preferably from 0.4 to 2 parts by weight, or even more preferably from 0.5 to 2 parts by weight per 100 parts by weight of the copolymer (solid content in the emulsion). The amount of the polycarboxylate dispersing agent can also be set, for example, from 1 to 200 parts by weight, preferably from 2 to 100 parts by weight, or more preferably from 3 to 50 parts by weight per 100 parts by weight of the clay mineral. When the amount of the polycarboxylate dispersing agent exceeds the above range, dispersibility of the clay mineral may deteriorate. On the other hand, when the amount of the polycarboxylate dispersing agent is less than the above range, dispersion stability may deteriorate, which may in turn generate aggregates.

As the dispersing apparatus, for example, an ultrasonic dispersing apparatus, a homomixer or a high-pressure homogenizer is used.

The adhesive composition of the present invention can be obtained as the emulsion, that is, the aqueous dispersion adhesive composition, by mixing the aqueous dispersion of the clay mineral with the aqueous dispersion of the copolymer as described above.

Additives such as viscosity modifiers, crosslinking agents, and if necessary, release modifiers, plasticizers, softening agents, fillers, colorant (such as pigments and dyes), antioxidant and surfactant can be added to the adhesive composition thus obtained. The amount of these additives is not particularly limited and can be selected.

The viscosity modifier is not particularly limited and examples thereof include an acrylic thickener.

Examples of the crosslinking agent include isocyanate crosslinking agent, epoxy crosslinking agent, oxazoline crosslinking agent, aziridine crosslinking agent and metal chelate crosslinking agent. These crosslinking agents are not particularly limited, and an oil-soluble or water-soluble crosslinking agent may be used. These crosslinking agents are appropriately used alone or in combination, and the amount thereof is, for example, from 0.1 to 10 parts by weight per 100 parts by weight of the solid content in the emulsion.

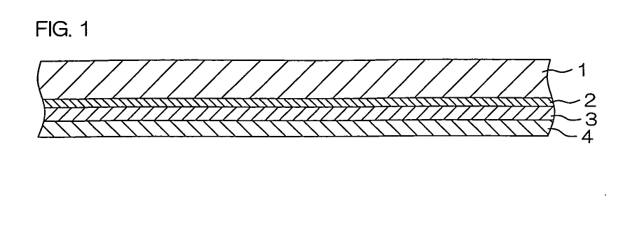

A method for producing the adhesive optical film as an embodiment of an adhesive optical film according to the present invention, will be described below with reference to FIG. 1.

The adhesive optical film of the present invention includes an optical film 1, an adhesive layer 3 laminated on at least one side of the optical film 1, and an undercoat layer 2 interposed between the optical film 1 and the adhesive layer 3.

The optical film 1 is not particularly limited as long as it is a film which has optical characteristics and is bonded to a liquid crystal display or the like. Examples thereof include polarizing film, phase difference film, luminance improving film and view-angle expansion film.

As the polarizing film, those having a transparent protective film provided on one side or both sides of the polarizer are used.

The polarizer is not particularly limited, and examples thereof include those obtained by dyeing hydrophilic polymer films such as polyvinyl alcohol film, partially formulated polyvinyl alcohol film and ethylene-vinyl acetate copolymer partially saponified film with a dichromatic substance such as iodine or dichromatic dye, and then uniaxially stretching the dyed film; and polyene oriented films subjected to a dehydration treatment of polyvinyl alcohol or a dehydrochlorination treatment of polyvinyl chloride. A polarizer obtained by dyeing a polyvinyl alcohol film with iodine and then uniaxially stretching the dyed film is preferable.

Examples of the transparent protective film include polyester polymer film such as polyethylene terephthalate or polyethylene naphthalate, cellulose polymer film such as diacetyl cellulose or triacetyl cellulose, acrylic polymer film such as polymethyl methacrylate, styrene polymer film such as polystyrene or acrylonitrile-styrene copolymer (AS resin) and polycarbonate polymer film. The transparent protective film further includes polyolefin polymer film such as polyethylene, polypropylene, polyolefin having a cyclo or norbornene structure or ethylene-propylene copolymer, vinyl chloride polymer film, nylon, amide polymer film such as aromatic polyamide, imide polymer film, sulfone polymer film, polyethersulfone polymer film, polyether ether ketone polymer film, polyphenylene sulfide polymer film, vinyl alcohol polymer film, vinylidene chloride polymer film, vinyl butyral polymer film, allylate polymer film, polyoxymethylene polymer film, epoxy polymer film, or films such as a blend of the above polymers.

The transparent protective film can be formed as a cured layer made of an acrylic, urethane, acryl-urethane, epoxy or silicone thermosetting or ultraviolet curable resin.

The transparent protective film is preferably made of a cellulose polymer. The thickness of the transparent protective film is not particularly limited and is, for example, 500 μm or less, preferably from 1 to 300 μm, more preferably from 5 to 200 μm.

The polarizer is bonded with the transparent protective film using an isocyanate adhesive, a polyvinyl alcohol adhesive, a gelatin adhesive, a vinyl adhesive, a latex adhesive or water polyester adhesive.

Examples of the phase difference film include double refraction film obtained by uniaxially or biaxially stretching a polymer material, oriented film of a liquid crystal polymer, and film including an oriented layer made of a liquid crystal polymer supported thereon. The thickness of the phase difference film is not particularly limited and is, for example, from 20 to 150 μm.

Examples of the polymer material include polyvinyl alcohol, polyvinyl butyral, polymethyl vinyl ether, polyhydroxyethyl acrylate, hydroxyethyl cellulose, hydroxypropyl cellulose, methyl cellulose, polycarbonate, polyarylate, polysulfone, polyethylene terephthalate, polyethylene naphthalate, polyether sulfone, polyphenylene sulfide, polyphenylene oxide, polyallyl sulfone, polyamide, polyimide, polyolefin, polyvinyl chloride, cellulose polymer, or various two-dimensional or three-dimensional copolymers thereof, graft copolymer and blends. These polymer materials are formed into an oriented substance (stretched film) by stretching.

Examples of the liquid crystal polymer include various main chain or side chain type liquid crystal polymers in which a conjugated linear atomic group (mesogen) imparting liquid crystal orientation is introduced into the main chain or side chain of the polymer. The main chain type liquid crystal polymer has a structure in which a mesogenic group is attached at the spacer moiety imparting flexibility, and specific examples thereof include nematically oriented polyester liquid crystal polymer, discotic polymer and cholesteric polymer. Examples of the side chain type liquid crystal polymer include those which contain polysiloxane, polyacrylate, polymethacrylate or polymalonate as a main chain skeleton and also have, as a side chain, a mesogenic moiety composed of a para-substituted cyclic compound unit capable of imparting nematic orientation via a spacer moiety composed of a conjugated atomic group. These liquid crystal polymers are obtained by spreading a solution of a liquid crystal polymer over an oriented surface such as the surface of a thin film made of polyimide or polyvinyl alcohol formed on a glass plate subjected to a rubbing treatment, or to an oblique deposition with silicon oxide, and then conducting heat treatment.

The phase difference film may be one used for the purpose of coloring of films having various wavelengths and a liquid crystal layer due to double refraction or of enlarging a view angle, or one having phase difference according to the purpose of use, or optical characteristics such as phase difference is controlled by laminating two or more phase difference films.

Examples of the luminance improving film include those having a characteristic to transmit linear polarization of a predetermined polarizing axis and reflect other light, such as multilayered thin film of dielectrics or multilayered laminate of thin films each having different refractive index anisotropy; and those having a characteristic to reflect either left-hand or right-hand circularly polarized light and transmit the other light, such as oriented film of a cholesteric liquid crystal polymer or a film having an oriented liquid crystal layer supported on the base material.

The view-angle expansion film is a film used to enlarge a view angle so that images can be seen relatively clearly when the image plane of the liquid crystal display is viewed from a slightly diagonal direction relative to the image plane, not from a perpendicular direction to the image plane. Examples thereof include phase difference film, oriented film made of liquid crystal polymer, and film having an oriented layer such as a liquid crystal polymer supported on a transparent base material. Examples of the phase difference film used as the view-angle expansion film include polymer film having double refraction obtained by biaxially stretched in the plane direction; polymer film having double refraction, in which refractive index in the thickness direction is controlled, obtained by uniaxially stretching in the plane direction and also under stretch in the thickness direction, and biaxially stretched film such as inclined oriented film.

An undercoat layer 2 is provided on one side of the optical film 1. In this description, the undercoat layer 2 is provided on one side of the optical film 1. However, although not shown in FIG. 1, it can also be provided on both sides of the optical film 1 as required.

The undercoat layer 2 contains at least one kind selected from the group consisting of an oxazoline group-containing polymer, a compound having a plurality of carboxyl groups, a water-soluble or aqueous dispersion electrically conductive material and a polyamine polymer.

The oxazoline group-containing polymer contains a main chain being of an acryl skeleton or a styrene skeleton and has an oxazoline group in a side chain of the main chain, preferably an oxazoline group-containing acrylic polymer having a main chain being of an acryl skeleton and having an oxazoline group in a side chain of the main chain.

Examples of the oxazoline group include 2-oxazoline group, 3-oxazoline group and 4-oxazoline group, and a 2-oxazoline group is preferable.

The 2-oxazoline group is generally represented by the following general formula (4):

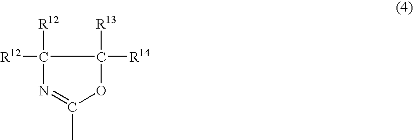

in the general formula (4), R¹²R¹³R¹⁴ and R¹⁵ each independently represents a hydrogen atom, a halogen atom, an alkyl group, an aralkyl group, a phenyl group or a substituted phenyl group.

The number average molecular weight of the oxazoline group-containing polymer is, for example, 5000 or more, preferably 10000 or more, and usually 1000000 or less. When the number average molecular weight is lower than 5000, cohesive failure may be caused because of poor strength of the undercoat layer 2, whereby an anchoring force may not be improved. When the number average molecular weight is higher than 1000000, workability may be inferior. The oxazoline value of the oxazoline group-containing polymer is, for example, 1500 g solid/eq. or less, or preferably 1200 g solid/eq. or less. When the oxazoline value is larger than 1500 g solid/eq., the amount of the oxazoline group in a molecule decreases, whereby the anchoring force may not be improved.

As the oxazoline group-containing polymer, commercially available products are usually used, and examples thereof include oxazoline group-containing acrylic polymers such as EPOCROS WS-500 (water-soluble type, solid content: 40%, main chain: acrylic, pH 7 to 9, oxazoline value: 220 g solid/eq., manufactured by Nippon Shokubai Co., Ltd.) and EPOCROS WS-700 (water-soluble type, solid content: 25%, main chain: acrylic, pH 7 to 9, oxazoline value: 220 g solid/eq., manufactured by Nippon Shokubai Co., Ltd.); and oxazoline group-containing acryl/styrene polymers such as EPOCROS K-1000 series (emulsion type, solid content: 40%, main chain: styrene/acrylic, oxazoline value: 1100 g solid/eq., pH 7 to 9, manufactured by Nippon Shokubai Co., Ltd.) and EPOCROS K-2000 series (emulsion type, solid content: 40%, main chain: styrene/acrylic, pH 7 to 9, oxazoline value: 550 g solid/eq., manufactured by Nippon Shokubai Co., Ltd.). In view of improvement in adhesion, a water-soluble type oxazoline group-containing polymer is more preferable than an emulsion type oxazoline group-containing polymer containing an emulsifier.

These oxazoline group-containing polymers can be used alone or in combination of two or more kinds.

Since the oxazoline group of the oxazoline group-containing polymer reacts with a functional group (such as carboxyl group) contained in the adhesive composition at relatively low temperatures, the oxazoline group-containing polymer reacts with the functional group in the adhesive layer 3 or the like and can firmly adhere to the adhesive layer 3 when contained in the undercoat layer 2.

Examples of the compound having a plurality of carboxyl groups include saturated low molecular weight compounds having a plurality of carboxyl groups, for example, dicarboxylic acid compounds such as succinic acid, adipic acid and phthalic acid; and tricarboxylic acid compounds such as citric acid.

The compound having a plurality of carboxyl groups is a polymer compound, and examples thereof include polymers of unsaturated compounds such as acrylic acid and methacrylic acid (e.g., polyacrylic acid and polymethacrylic acid); and copolymers of these unsaturated compounds, specifically copolymer of acrylic acid and methacrylic acid, copolymer of acrylic acid and maleic acid, copolymer of methacrylic acid and maleic acid, copolymer of acrylic acid, methacrylic acid and maleic acid. A copolymer of acrylic acid and maleic acid are preferable.

The number average molecular weight (measured by GPC in terms of standard polyethyleneglycol) of the compound having a plurality of carboxyl groups is, for example, 1000 or more, or preferably from 3000 to 200000.

As the compound having a plurality of carboxyl groups, commercially available products are used, and specific examples thereof include POISE 532A (acrylic acid/maleic acid copolymer ammonium salt, number average molecular weight: about 10000, manufactured by Kao Corporation).

These compounds having a plurality of carboxyl groups can be used alone or in combination of two or more kinds.

The water-soluble electrically conductive material is not particularly limited as long as the electrically conductive material exhibits water solubility, and has a solubility of, for example, 5 g or more, or preferably from 20 to 30 g per 100 g of water. Less than 5 g of the solubility per 100 g of water may hinder industrial formation of a coating.

The aqueous dispersion electrically conductive material is not particularly limited as long as it is a fine-particulate, electrically conductive material capable of dispersing in water, and the fine particles have an average particle diameter (size) of, for example, 1 μm or less from the viewpoint of homogeneity of the undercoat layer 2. The aqueous dispersion electrically conductive material has a small liquid viscosity in the aqueous dispersion (corresponding to the coating solution to be described later), is easily coated (thin film coating) to form the undercoat layer 2, and, in addition, excellent in homogeneity of the aqueous dispersion electrically conductive material in the undercoat layer 2.

Examples of the water-soluble or aqueous dispersion electrically conductive material include an electrically conductive polymer and an organometallic compound.

Examples of the conductive polymer include polyaniline, polythiophene, polypyrrole and polyquinoxaline. Among these polymers, polyaniline or polythiophene is preferable from the viewpoint of coating.

Polyaniline has a weight average molecular weight, which is measured by GPC in terms of polystyrene, of, for example, 500000 or, less, or preferably 300000 or less. Polythiophene has a weight average molecular weight, which is measured by GPC in terms of polystyrene, of, for example, 400000 or less, or preferably 300000 or less.

When the weight average molecular weight of the polyaniline or polythiophene exceeds the above value, the polyaniline or polythiophene no longer exhibits any of the water solubility and the water dispersibility described above. In addition to this, when a coating solution containing such polyaniline or polythiophene is prepared, the solid content of the polyaniline or the polythiophene in the coating solution partially remains, or the viscosity of the polyaniline or the polythiophene partially increases. Accordingly, this tends to develop difficulty in forming the undercoat layer 2 having a uniform thickness.

The polyaniline or the polythiophene preferably has a hydrophilic functional group in its molecule.

Examples of the hydrophilic functional group include a sulfo group, an amino group, an amide group, an imino group, a quaternary ammonium salt group, a hydroxyl group, a mercapto group, a hydrazino group, a carboxyl group, a sulfate group (—O—SO₃H), a phosphate group (—O—PO(OH)₂) or salts thereof (except a quaternary ammonium salt group). Since polyaniline or polythiophene has such hydrophilic functional group in its molecule, it easily dissolve or disperse in water, so that a coating solution of polyaniline or polythiophene can be easily prepared.

As the water-soluble or aqueous dispersion electrically conductive polymer, commercially available products can be used. Among these polymers, polyaniline sulfonic acid (Mitsubishi Rayon Co., Ltd.) may be used as the water-soluble conductive polymer and polythiophene conductive polymer (manufactured by Nagase ChemteX Corporation, under the trade name of “Denatron” (Denatron series)) may be used as the aqueous dispersion electrically conductive polymer.

Examples of the organometallic compound include metal alkoxide, metal chelate, organic metal salt, and organic metal oxide, which are used as polymer crosslinking agents, and an organic zirconium compound, an organic titanium compound, or an organic aluminium compound may be used depending on the kind of metal.

Examples of the organic zirconium compound include zirconium alkoxide, zirconium chelate, and zirconium acylate.

Examples of the organic titanium compound include titanium alkoxide, titanium chelate and titanium acylate.

Examples of the organic aluminium compound include aluminum alkoxide, aluminum chelate and aluminium acylate.

These electrically conductive materials can be used alone or in combination of two or more kinds.

The polyamine polymer is a polymer having a plurality of primary or secondary amino groups in a molecule, and examples thereof include polyethyleneimine; polyallylamine: and ethyleneimine-modified acrylic polymer and allylamine-modified acrylic polymer in which a main chain of an acryl skeleton is contained and a polyethyleneimine chain represented by the following general formula (5) or a polyallylamine chain represented by the following general formula (6) is modified in a side chain of the main chain. Ethyleneimine-modified acrylic polymer is preferable.

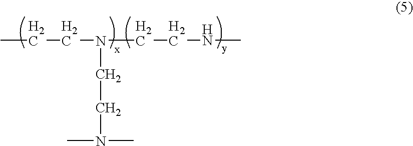

in the general formula (5), x and y represent the degree of polymerization of a polyethyleneimine chain.

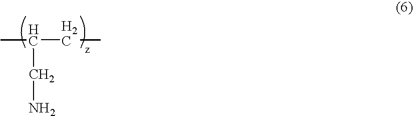

in the general formula (6), z represents the degree of polymerization of a polyallylamine chain.

The number average molecular weight of the polyamine polymer is, for example, 200 or more, preferably 1000 or more, or more preferably 8000 or more, and usually 1000000 or less. When the number average molecular weight is less than 200, cohesive failure may be caused because of poor strength of the undercoat layer 2 and the anchoring force may not be improved. On the other hand, when the number average molecular weight is more than 1000000, workability may be inferior. The amine hydrogen equivalent of the polyamine polymer is, for example, 1500 g solid/eq. or less, or preferably 1200 g solid/eq. or less. When the amine hydrogen equivalent is more than 1500 g solid/eq., the amount of the amino group contained in the molecule decreases and the anchoring force may not be improved.

As the polyamine-polymer, commercially available products are used, and specific examples thereof include polyethyleneimines such as EPOMIN SP-003 (water-soluble type, amine hydrogen equivalent: 47.6 g solid/eq., manufactured by Nippon Shokubai Co., Ltd.), EPOMIN SP-006 (water-soluble type, amine hydrogen equivalent: 50.0 g solid/eq., manufactured by Nippon Shokubai Co., Ltd.), EPOMIN SP-012 (water-soluble type, amine hydrogen equivalent: 52.6 g solid/eq., manufactured by Nippon Shokubai Co., Ltd.), EPOMIN SP-018 (water-soluble type, amine hydrogen equivalent: 52.6 g solid/eq., manufactured by Nippon Shokubai Co., Ltd.), EPOMIN SP-103 (water-soluble type, amine hydrogen equivalent: 52.6 g solid/eq., manufactured by Nippon Shokubai Co., Ltd.), EPOMIN SP-110 (water-soluble type, amine hydrogen equivalent: 55.6 g solid/eq., manufactured by Nippon Shokubai Co., Ltd.), EPOMIN SP-200 (water-soluble type, amine hydrogen equivalent: 55.6 g solid/eq., manufactured by Nippon Shokubai Co., Ltd.) and EPOMIN P-1000 (water-soluble type, amine hydrogen equivalent: 52.6 g solid/eq., manufactured by Nippon Shokubai Co., Ltd.); ethyleneimine-modified acrylic polymers such as POLYMENT SK-1000 (emulsion type, amine hydrogen equivalent: 650 g solid/eq., manufactured by Nippon Shokubai Co., Ltd.), POLYMENT NK-350 (solvent type, amine hydrogen equivalent: 1100 g solid/eq., manufactured by Nippon Shokubai Co., Ltd.), POLYMENT NK-380 (solvent type, amine hydrogen equivalent: 1100 g solid/eq., manufactured by Nippon Shokubai Co., Ltd.), POLYMENT NK-100PM (water-soluble type, amine hydrogen equivalent: 350 to 450 g solid/eq., manufactured by Nippon Shokubai Co., Ltd.) and POLYMENT NK-200PM (water-soluble type, amine hydrogen equivalent: 350 to 450 g solid/eq., manufactured by Nippon Shokubai Co., Ltd.).

These polyamine polymers can be used alone or in combination of two or more kinds.

Examples of the undercoat layer 2 include preferably a layer made of only an oxazoline group-containing polymer; a layer made of only an electrically conductive material; a layer made of a mixture of an oxazoline group-containing polymer and a compound having a plurality of carboxyl groups; a layer made of a mixture of an oxazoline group-containing polymer and an electrically conductive material; a layer made of a mixture of an oxazoline group-containing polymer, a compound having a plurality of carboxyl groups and an electrically conductive material; and a layer made of a mixture of an oxazoline group-containing polymer and a polyamine polymer.

When the undercoat layer 2 is made of a mixture of a compound having an oxazoline group-containing polymer and a plurality of carboxyl groups, the undercoat layer 2 is crosslinked by reaction between the oxazoline group of the oxazoline group-containing polymer and the carboxyl group of the compound having a plurality of carboxyl groups. Therefore, the undercoat layer 2 becomes firmer to improve heat resistance and moist heat resistance, whereby adhesion can be enhanced.

When the undercoat layer 2 is made of a mixture of an oxazoline group-containing polymer and an electrically conductive material, the undercoat layer 2 can be formed as an antistatic layer. At the same time, the undercoat layer 2 is excellent in affinity with an aqueous dispersion adhesive composition, which enhances adhesion between an optical film and the aqueous dispersion adhesive composition. Therefore, an adhesive optical film having excellent heat resistance can be obtained. As a result, an adhesive optical film having better reworkability, excellent heat resistance and an antistatic function can be obtained.

When the undercoat layer 2 is made of a mixture of an oxazoline group-containing polymer, a compound having a plurality of carboxyl groups and an electrically conductive material, the undercoat layer 2 can be formed as an antistatic layer. At the same time, the undercoat layer 2 is crosslinked by reaction between the oxazoline group of the oxazoline group-containing polymer and the carboxyl group of the compound having a plurality of carboxyl groups. Therefore, the undercoat layer 2 becomes firmer to improve heat resistance and moist heat resistance, whereby adhesion can be enhanced.

When the undercoat layer 2 is made of a mixture of an oxazoline group-containing polymer and a polyamine polymer, the undercoat layer 2 can impart excellent moist heat resistance to an adhesive optical film while maintaining high adhesion and heat resistance that are obtained when the undercoat layer 2 is made of only an oxazoline group-containing polymer. As a result, an adhesive optical film having excellent adhesion, heat resistance and moist heat resistance can be obtained.

When the undercoat layer 2 is made of a mixture of an oxazoline group-containing polymer and a compound having a plurality of carboxyl groups, the amount of the compound having a plurality of carboxyl groups is, for example, from 1 to 30 parts by weight, preferably from 2 to 20 parts by weight, or more preferably from 3 to 10 parts by weight per 100 parts by weight of the total amount of the mixture. When the amount of the compound having a plurality of carboxyl groups is less than 1 part by weight, the effect of crosslinking the undercoat layer 2 may be lowered. On the other hand, When the amount of the compound having a plurality of carboxyl groups is more than 30 parts by weight, the undercoat layer 2 may become opaque, which may deteriorate the optical characteristics.

When the undercoat layer 2 is made of a mixture of an oxazoline group-containing polymer and an electrically conductive material, the amount of the oxazoline group-containing polymer is, for example, from 10 to 500 parts by weight, or preferably from 20 to 400 parts by weight per 100 parts by weight of the electrically conductive material.

When the undercoat layer 2 is made of a mixture of an oxazoline group-containing polymer, a compound having a plurality of carboxyl groups and an electrically conductive material, the amount of the compound having a plurality of carboxyl groups is, for example, from 1 to 30 parts by weight, preferably from 2 to 20 parts by weight, or more preferably from 3 to 10 parts by weight per 100 parts by weight of the total amount of the mixture. The amount of the oxazoline group-containing polymer and the amount of the electrically conductive material are the same as those of the respective components when the undercoat layer 2 described above is made of a mixture of an oxazoline group-containing polymer and an electrically conductive material.

When the undercoat layer 2 is made of a mixture of an oxazoline group-containing polymer and a polyamine polymer, the amount of the polyamine polymer is, for example, from 50 to 98 parts by weight, preferably from 70 to 97 parts by weight, or more preferably from 80 to 95 parts by weight per 100 parts by weight of the total amount of the mixture. When the amount of the polyamine polymer is less than 50 parts by weight, moist heat resistance may be inferior. On the other hand, when the amount of the polyamine polymer is more than 98 parts by weight, heat resistance may be inferior.

Each of the above components (oxazoline group-containing polymer, compound having a plurality of carboxyl groups, electrically conductive material or polyamine polymer, or a mixture thereof) is dissolved or dispersed in a solvent and is prepared as a solution or dispersion of each of the components.

Preferably, each of the components is prepared as an aqueous solution or an aqueous dispersion (hereinafter simply referred to as “coating solution”), in which the components are dissolved or dispersed in water, from the viewpoint of preventing degradation of the optical film. Such coating solution does not require using nonaqueous organic solvent, so that degradation of the optical film 1 due to the organic solvent can be suppressed.

As an aqueous solvent, alcohols other than water can be further contained in the coating solution.

Examples of the alcohols include methanol, ethanol, n-propanol, isopropanol, n-butanol, isobutanol, sec-butanol, tert-butanol, n-amyl alcohol, isoamyl alcohol, sec-amyl alcohol, tert-amyl alcohol, 1-ethyl-1-propanol, 2-ethyl-1-butanol, n-hexanol and cyclohexanol.

In the coating solution, the amount of each of the components is, for example, from 0.05 to 80% by weight, or preferably from 0.1 to 50% by weight.

The undercoat layer 2 is provided, for example, by directly coating the optical film 1 with the above coating solution of the undercoat layer using a known coating method such as knife coating method, and then drying the coating.

The thickness (thickness after drying) of the undercoat layer 2 is set within a range, for example, from 10 to 1000 nm, preferably from 20 to 500 nm, or more preferably from 30 to 200 nm.

When the undercoat layer 2 includes an electrically conductive material, that is, the undercoat layer 2 is formed as an antistatic layer, the surface resistance thereof is usually, preferably 1×10¹² ο/□ or less, more preferably 1×10¹¹ ο/□ or less, or even more preferably 1×10¹⁰ ο/□ or less. When the surface resistance thereof exceeds 1×10¹² ο/□, the antistatic function may not be satisfactory.

Next, an adhesive layer 3 is provided on at least one side of the optical film 1 via the undercoat layer 2.

The adhesive layer 3 is provided, for example, by transferring the adhesive layer 3 to the above-mentioned undercoat layer 2 from a release sheet 4 formed with the adhesive layer 3. The release sheet 4 formed with the adhesive layer 3 is produced by directly coating the above-mentioned adhesive composition on the release sheet 4 using a known coating method such as knife coating method. Thereafter, the adhesive layer 3 is provided on the release sheet 4, for example, by heating to dry the release sheet 4 thus coated at a temperature of from 80 to 150° C. for 1 to 10 minutes. To transfer the adhesive layer 3, the release sheet 4 formed with the adhesive layer 3 is bounded to the undercoat 2 and then the release sheet 4 is removed from the adhesive layer 3.

The adhesive layer 3 can also be formed, for example, by directly coating the above-mentioned adhesive composition onto the above-mentioned undercoat layer 2 using a known coating method such as knife coating method, and then heating to dry the adhesive layer 3 thus coated at a temperature of from 80 to 150° C. for 1 to 10 minutes.

Examples of the release sheet 4 include synthetic resin film made of paper, polyethylene, polypropylene or polyethylene terephthalate; rubber sheet; fabric; nonwoven fabric; net; foamed sheet; metal foil; and laminated sheet material thereof. If necessary, the surface of the release sheet 4 may be subjected to a treatment (release treatment) such as silicone treatment, long chain alkyl treatment or fluorine treatment so as to enhance releasability from the adhesive layer 3.

The thickness (thickness after drying) of the adhesive layer 2 is set within a range, for example, from 1 to 100 μm, preferably from 5 to 50 μm, or more preferably from 10 to 30 μm.

An adhesive optical film can thus be obtained by providing the adhesive layer 3 formed of the above-mentioned adhesive composition on at least one side of the optical film 1 via the undercoat layer 2.

The adhesive optical film thus obtained is suitably used in various industrial applications as adhesive optical films such as polarizing film, phase difference film, luminance improving film and view-angle expansion film.

Since the adhesive optical film has high adhesion between the adhesive layer 3 and a glass substrate of a liquid crystal display and also has high adhesion between the adhesive layer 3 formed of the above-mentioned adhesive composition and the optical film 1, firm adhesion between the optical film 1 and a substrate can be achieved. Therefore, a lack of adhesive and residue of an adhesive during handling of the adhesive optical film can be effectively suppressed.

Since the adhesive optical film also shows high adhesion even in adhesion to a glass substrate of a liquid crystal display, the adhesive optical film can be firmly adhered to a glass substrate.

The adhesive optical film is excellent in transparency. Further, the adhesive optical film has excellent heat resistance and moisture resistance, so that excellent adhesion to a substrate under a high temperature and high humidity atmosphere can be obtained. In particular, even when a relatively thick optical film which imparts a significant load onto an adhesive layer, excellent adhesion to a glass substrate under a high temperature atmosphere can be maintained.

Therefore, the adhesive optical film is stuck onto the surface of a substrate in an image display device such as liquid crystal display, organic electroluminescence device (organic EL display device) and plasma display panel (PDP) via the undercoat layer 2 and the adhesive layer 3. As a result, good appearance can be ensured, and an image display device having excellent heat resistance and moisture resistance can be obtained.

### EXAMPLES

The present invention will now be described in more detail by way of Examples and Comparative Examples. However, the present invention is not limited to the following Examples and Comparative Examples. In the following description, the units “part(s)” and “%” are by weight, unless otherwise noted.

### Example 1

### Preparation of Monomer Preemulsion

In a vessel, 100 parts of butyl acrylates, 5 parts of acrylic acid, 2 parts of mono[poly(propylene oxide)methacrylate]phosphate ester (PAM-200, average degree of polymerization of propylene oxide: about 5.0, manufactured by Rhodia Nicca, Ltd.), and 0.01 parts of 3-methacryloyloxypropyl-trimethoxysilane (KBM-503, manufactured by SHIN-ETSU CHEMICAL CO., LTD.) were charged and mixed to prepare a monomer component.

Subsequently, to 627 g of the monomer component thus prepared, 13 g of a reactive emulsifier AQUALON HS-10 (manufactured by Dai-Ichi Kogyo Seiyaku Co., Ltd.) and 360 g of ion-exchange water were added, and the mixture was forcibly emulsified with stirring at 5000 (1/min) for 5 minutes using a homogenizer (manufactured by Tokusyu Kika Kogyo Co., Ltd.) to prepare a monomer preemulsion.

### Preparation of Emulsion

In a reaction vessel equipped with a condenser tube, a nitrogen introducing tube, a thermometer and a stirrer, 200 g of the resulting monomer preemulsion and 300 g of ion-exchange water were charged, and subsequently, the atmosphere in the reaction vessel was replaced by nitrogen. Thereafter, 0.2 g of 2,2′-azobis[N-(2-carboxyethyl)-2-methylpropioneamidine]hydrate (VA-057, manufactured by Wako Pure Chemicals Industries, Ltd.) was added thereto, and the added mixture was polymerized at 60° C. for 1 hour. Then, 800 g of the remaining monomer preemulsion was added dropwise in the reaction vessel over for 3 hours, and thereafter, polymerization was conducted for 3 hours. Polymerization was then further conducted at 60° C. for 3 hours while the atmosphere was replaced by nitrogen to obtain an emulsion (aqueous dispersion of a copolymer) having a solid content of 48%.

After the emulsion was cooled to room temperature, the pH was adjusted to 8 by adding 10% aqueous ammonia, and 3.0 g of an acrylic thickener (ARON B-500, manufactured by Toagosei Co., Ltd.) was further added thereto.

### Preparation of Aqueous Dispersion of Clay Mineral

After 0.5 parts of sodium hexametaphosphate (phosphate dispersing agent, manufactured by Kishida Chemical Co., Ltd.) was added to 90 parts of ion-exchange water to be dissolved, 10 parts of Lucentite SPN (smectite obtained by subjecting the interlayers to a hydrophobic treatment using a quaternary ammonium salt (cationic dispersing agent) containing a propylene oxide skeleton having a hydroxyl group at its terminal in a ratio of 120 mol eq./100 g; maximum theoretical length in each layer: 50 nm; content ratio of clay constituent/cationic dispersing agent=40 parts/60 parts; manufactured by CO-OP CHEMICAL CO., LTD.) was added thereto, and the added mixture was allowed to stand for 48 hours. Then, the Lucentite SPN was dipped in ion-exchange water to be swelled. Then, the resulting product was dispersed with stirring at 7000 (1/min) for 15 minutes using a homogenizer (manufactured by Tokusyu Kika Kogyo Co., Ltd.) to prepare an aqueous dispersion of a clay mineral.

### Preparation of Aqueous Dispersion Adhesive Composition

The aqueous dispersion of the clay mineral was mixed with an emulsion (emulsion to which a pH adjusting agent and an additive were added) so that the amount of the clay mineral (Lucentite SPN) in the aqueous dispersion of the clay mineral was 10 parts (content of the clay constituent: 4 parts) per 100 parts of the solid content (copolymer) in the emulsion to prepare an aqueous dispersion adhesive composition.

### Preparation of Optical Film

A polyvinyl alcohol film having a thickness of 80 μm was stretched by 5 times as long as the original length in an iodine aqueous solution at 40° C. Subsequently, the polyvinyl alcohol film was drawn up from the iodine aqueous solution and then dried at 50° C. for 4 minutes to obtain a polarizer having a thickness of 20 μm. Using a polyvinyl alcohol adhesive, a triacetyl cellulose film having a thickness of 40 μm and a triacetyl cellulose film having a thickness of 80 μm as transparent protective films were independently bonded to both sides of the polarizer to obtain two kinds of optical films including a thin polarizing film having a thickness of 100 μm and a standard polarizing film having a thickness of 180 μm.

Formation of Undercoat layer

EPOCROS WS-700 (oxazoline group-containing acrylic polymer, manufactured by Nippon Shokubai Co., Ltd.) was diluted with a mixed solvent of water and ethanol (weight ratio: 1:1) so as to adjust the solid content to 0.25%, thereby preparing a coating solution for undercoat layer. Using a wire bar #5, the coating solution was applied onto one side of each of the two kinds of optical films, and then dried at 40° C. for 2 minutes to form an undercoat layer.

### Production of Adhesive Optical Film

The aqueous dispersion adhesive composition was coated onto a release film (polyethylene terephthalate base material, DIAFOIL MRF38, manufactured by Mitsubishi Polyester Film Corporation) so that the coating had a thickness of 23 μm after drying. Then, the coating was heated to dry in a hot air circulation type oven at 100° C. for 2 minutes to form an adhesive layer on the release film. The adhesive layer thus formed was stuck onto each of the treatment surfaces (surfaces on the undercoat layer side) of the two kinds of optical films previously provided with the undercoat layers, to produce an adhesive optical film.

### Example 2

In the same manner as in Example 1, except that the amount of the clay mineral (Lucentite SPN) in the aqueous dispersion of the clay mineral was changed to 5 parts (content of the clay constituent: 2 parts) in the preparation of the aqueous dispersion adhesive composition in Example 1, an aqueous dispersion adhesive composition was prepared and an adhesive optical film was then produced.

### Example 3

In the same manner as in Example 1, except that the amount of the sodium hexametaphosphate was changed to 1 part in the preparation of the aqueous dispersion of the clay mineral in Example 1, an aqueous dispersion of a clay mineral was prepared, subsequently an aqueous dispersion adhesive composition was prepared and an adhesive optical film was then produced.

### Example 4

In the same manner as in Example 1, except that EPOCROS WS-700 was replaced by a mixture of EPOCROS WS-700 and POISE 532A (acrylic acid/maleic acid copolymer ammonium salt, number average molecular weight: about 10000, manufactured by Kao Corporation) so that the mixing ratio of EPOCROS WS-700 and POISE 532A was set to 95:5 and the solid content in the coating solution was changed to 2% in the preparation of the coating solution for formation of the undercoat layer in Example 1, an undercoat layer was formed and an adhesive optical film was then produced.

### Example 5

In the same manner as in Example 1, except that EPOCROS WS-700 was replaced by Denatron P502RG (polythiophene electrically conductive polymer, manufactured by Nagase ChemteX Corporation) and the solid content in the coating solution was changed to 0.5% in the preparation of the coating solution for formation of the undercoat layer in Example 1, an undercoat layer was formed and an adhesive optical film was then produced.

### Example 6

In the same manner as in Example 1, except that EPOCROS WS-700 was replaced by a mixture of EPOCROS WS-700 and Denatron P502RG so that the mixing ratio of EPOCROS WS-700 and Denatron P502RG was set to 1:2 and the solid content in the coating solution was changed to 0.75% in the preparation of the coating solution for formation of the undercoat layer in Example 1, an undercoat layer was formed and an adhesive optical film was then produced.

### Example 7

In the same manner as in Example 1, except that EPOCROS WS-700 was replaced by a mixture of EPOCROS WS-700, POISE 532A and Denatron P502RG so that the mixing ratio of EPOCROS WS-700, POISE 532A and Denatron P502RG was set to 190:10:25 and the solid content in the coating solution was changed to 2.25% in the preparation of the coating solution for formation of the undercoat layer in Example 1, an undercoat layer was formed and an adhesive optical film was then produced.

### Example 8

In the same manner as in Example 1, except that EPOCROS WS-700 was replaced by a mixture of EPOCROS WS-700 and ORGATIX ZB-125 (zirconium chloride compound, ZrO₂ content ratio: 15%, manufactured by Matsumoto Pharmaceutical Manufacture Co., Ltd.) so that the mixing ratio of EPOCROS WS-700 and ORGATIX ZB-125 was set to 1:2 and the solid content in the coating solution was changed to 0.75% in the preparation of the coating solution for formation of the undercoat layer in Example 1, an undercoat layer was formed and an adhesive optical film was then produced.

### Example 9

In the same manner as in Example 1, except that EPOCROS WS-700 was replaced by a mixture of EPOCROS WS-700 and ORGATIX TC-400 (diisopropoxytitanium bis(triethanolaminato), (C₃H₇O)₂Ti (C₆H₁₄O₃N)₂, Ti content ratio: 8%, manufactured by Matsumoto Pharmaceutical Manufacture Co., Ltd.) so that the mixing ratio of EPOCROS WS-700 and ORGATIX TC-400 was set to 1:2 and the solid content in the coating solution was changed to 0.75% in the preparation of the coating solution for formation of the undercoat layer in Example 1, an undercoat layer was formed and an adhesive optical film was then produced.

### Example 10

In the same manner as in Example 1, except that EPOCROS WS-700 was replaced by a mixture of EPOCROS WS-700 and POLYMENT SK-1000 (emulsion type, amine hydrogen equivalent: 650 g solid/eq., manufactured by Nippon Shokubai Co., Ltd.) so that the mixing ratio of EPOCROS WS-700 and POLYMENT SK-1000 was set to 1:1 and the solid content in the coating solution was changed to 0.50% in the preparation of the coating solution for formation of the undercoat layer in Example 1, an undercoat layer was formed and an adhesive optical film was then produced.

### Example 11

In the same manner as in Example 1, except that the amount of the clay mineral (Lucentite SPN) in the aqueous dispersion of the clay mineral was changed to 2 parts (content of the clay constituent: 0.8 parts) in the preparation of the aqueous dispersion adhesive composition in Example 1, an aqueous dispersion adhesive composition was prepared and an adhesive optical film was then produced.

### Example 12

In the same manner as in Example 1, except that the amount of the clay mineral (Lucentite SPN) in the aqueous dispersion of the clay mineral was changed to 20 parts (content of the clay constituent: 8 parts) in the preparation of the aqueous dispersion adhesive composition in Example 1, an aqueous dispersion adhesive composition was prepared and an adhesive optical film was then produced.

### Example 13

### Preparation of Aqueous Dispersion of Clay Mineral

Five parts of Kunipia F (smectite, not hydrophobic-treated, manufactured by Kunimine Industries Co., Ltd.) was added to 95 parts of ion-exchange water, and the resulting mixture was then dispersed with stirring at 7000 (1/min) for 15 minutes using a homogenizer (manufactured by Tokusyu Kika Kogyo Co., Ltd.) to prepare an aqueous dispersion of a clay mineral.

### Preparation of Aqueous Dispersion Adhesive Composition

In the same manner as in Example 1, except that the aqueous dispersion of the clay mineral was mixed so that the amount of the clay mineral (Kunipia F) in the aqueous dispersion of the clay mineral was 0.5 parts per 100 parts of the solid content in the emulsion in the preparation of the aqueous dispersion adhesive composition in Example 1, an aqueous dispersion adhesive composition was prepared and an adhesive optical film was then produced.

### Example 14

In the same manner as in Example 13, except that the amount of the clay mineral (Kunipia F) in the aqueous dispersion of the clay mineral was changed to 1 part in the preparation of the aqueous dispersion adhesive composition in Example 13, an aqueous dispersion adhesive composition was prepared and an adhesive optical film was then produced.

### Example 15

In the same manner as in Example 13, except that the amount of the clay mineral (Kunipia F) in the aqueous dispersion of the clay mineral was changed to 2 parts in the preparation of the aqueous dispersion adhesive composition in Example 13, an aqueous dispersion adhesive composition was prepared and an adhesive optical film was then produced.

### Example 16

In the same manner as in Example 13, except that the amount of the clay mineral (Kunipia F) in the aqueous dispersion of the clay mineral was changed to 4 parts in the preparation of the aqueous dispersion adhesive composition in Example 13, an aqueous dispersion adhesive composition was prepared and an adhesive optical film was then produced.

### Example 17

In the same manner as in Example 1, except that 0.5 parts of the sodium hexametaphosphate in Example 1 was changed to 1 part (solid content) of ARON A-208 (sodium polyacrylate, content of carboxyl anion: 6.5 mmol/g, manufactured by Toagosei Co., Ltd.), an aqueous dispersion of a clay mineral was prepared, subsequently an aqueous dispersion adhesive composition was prepared and an adhesive optical film was then produced.

### Example 18

In the same manner as in Example 1, except that 0.5 parts of the sodium hexametaphosphate in Example 1 was changed to 1 part (solid content) of AQUALIC TL-37 (copolymers of sodium acrylate/sodium maleate, content of carboxyl anion: 6.4 mmol/g, manufactured by Nippon Shokubai Co., Ltd.), an aqueous dispersion of a clay mineral was prepared, subsequently an aqueous dispersion adhesive composition was prepared and an adhesive optical film was then produced.

### Example 19

In the same manner as in Example 1, except that 0.5 parts of the sodium hexametaphosphate in Example 1 was changed to 1 part (solid content) of SHALLOL AN-103P (ammonium polyacrylate, content of carboxyl anion: 7.9 mmol/g, manufactured by Dai-Ichi Kogyo Seiyaku Co., Ltd.), an aqueous dispersion of a clay mineral was prepared, subsequently an aqueous dispersion adhesive composition was prepared and an adhesive optical film was then produced.

### Example 20

In the same manner as in Example 1, except that 0.5 parts of the sodium hexametaphosphate in Example 1 was changed to 1 part (solid content) of SN-Dispersant 5034 (sodium poly(meth)acrylate, content of carboxyl anion: 7.0 mmol/g, manufactured by San Nopco Limited), an aqueous dispersion of a clay mineral was prepared, subsequently an aqueous dispersion adhesive composition was prepared and an adhesive optical film was then produced.

### Comparative Example 1

In the same manner as in Example 1, except that the mono[poly(propylene oxide)methacrylate]phosphate ester was not added in the preparation of the monomer preemulsion in Example 1, a monomer preemulsion was prepared, and in the same manner as in Example 1, except that the sodium hexametaphosphate was not added in the preparation of the aqueous dispersion of the clay mineral, an aqueous dispersion of a clay mineral was prepared. Subsequently, in the same manner as in Example 1, an aqueous dispersion adhesive composition was prepared and an adhesive optical film was then produced.

### Comparative Example 2

In the same manner as in Example 1, except that the sodium hexametaphosphate and Lucentite SPN were not added in the preparation of the aqueous dispersion of the clay mineral in Example 1, an aqueous dispersion of a clay mineral was prepared, subsequently an aqueous dispersion adhesive composition was prepared and an adhesive optical film was then produced.

### Comparative Example 3

In the same manner as in Example 1, except that the amount of the clay mineral (Lucentite SPN) in the aqueous dispersion of the clay mineral was changed to 30 parts (content of the clay constituent: 12 parts) in the preparation of the aqueous dispersion adhesive composition in Example 1, an aqueous dispersion adhesive composition was prepared and an adhesive optical film was then produced.

The blending formulations of the aqueous dispersion adhesive composition and the coating solution of the undercoat layer in Examples 1 to 20 and Comparative Examples 1 to 3 are shown in Tables 1 and 2. The numerical values in the column of “Blending Formulation of Aqueous Dispersion Adhesive Composition” in Tables 1 and 2 represent amounts expressed in parts, unless otherwise specifically noted.

TABLE 1

| | | | | | | Examples | | | | | |
|---|---|---|---|---|---|---|---|---|---|---|---|
| | | | | | | Ex. | Ex. | Ex. | Ex. | Ex. | Ex. |
| | | | | | | 1 | 2 | 3 | 4 | 5 | 6 |
| Blending | Copolymer | Monomer | Alkyl(meth)- | Butyl Acrylate | | 100 | 100 | 100 | 100 | 100 | 100 |
| Formulation | | Component | acrylate | | | | | | | | |
| of Aqueous | | | Carboxyl Group- | Acrylic Acid | | 5 | 5 | 5 | 5 | 5 | 5 |
| Dispersion | | | Containing Vinyl | | | | | | | | |
| Adhesive | | | Monomer | | | | | | | | |
| Composition | | | Phosphoric Acid | PAM-200 | | 2 | 2 | 2 | 2 | 2 | 2 |
| | | | Group-Containing | | | | | | | | |
| | | | Vinyl Monomer | | | | | | | | |
| | | | Alkoxysilyl | KBM-503 | | 0.01 | 0.01 | 0.01 | 0.01 | 0.01 | 0.01 |
| | | | Group-Containing | | | | | | | | |
| | | | Vinyl Monomer | | | | | | | | |
| | Solid Content in Emulsion (Copolymer) | | | | | 100 | 100 | 100 | 100 | 100 | 100 |
| | Aqueous | Clay | Lucentite | per 100 | Clay | 4 | 2 | 4 | 4 | 4 | 4 |
| | Dispersion | Mineral | SPN | Parts of | Mineral | | | | | | |
| | of Clay | (Smectite) | (Hydrophobic- | Copolymer | (Clay | | | | | | |
| | Mineral | | treated) | | Constituent) | | | | | | |
| | | | | | Organic | 6 | 3 | 6 | 6 | 6 | 6 |
| | | | | | Componant | | | | | | |
| | | | | | (Cationic | | | | | | |
| | | | | | Dispersing | | | | | | |
| | | | | | Agent) | | | | | | |

| | Kunipia F (Not | per 100 | — | — | — | — | — | — |
|---|---|---|---|---|---|---|---|---|
| | hydrophobic- | Parts of | | | | | | |
| | treated) | Copolymer | | | | | | |
| (Anionic) | Type (phosphate/polycarboxylate) | | Na- | Na- | Na- | Na- | Na- | Na- |
| Dispersing | | | HMP | HMP | HMP | HMP | HMP | HMP |
| Agent | Content of Carboxyl Anion [mmol/g] | | — | — | — | — | — | — |
| | Amount | per 100 Parts | 0.5 | 0.5 | 1 | 0.5 | 0.5 | 0.5 |
| | | of Copolymer | | | | | | |
| | | per 100 Parts | 12.5 | 25 | 25 | 12.5 | 12.5 | 12.5 |
| | | of Clay Mineral | | | | | | |

| Coating | Oxazoline Group-Containing Polymer | | EPOCROS WS-700 | 0.25 | 0.25 | 0.25 | 1.9 | — | 0.25 |
|---|---|---|---|---|---|---|---|---|---|
| Solution of | Compound Having a Plurality | | POISE 532A | — | — | — | 0.1 | — | — |
| Undercoat | of Carboxyl Groups | | | | | | | | |
| Layer *1 | Electrically | Electrically | Denatron P502RG | — | — | — | — | 0.5 | 0.5 |
| | Conductive | Conductive | | | | | | | |
| | Material | Polymer | | | | | | | |
| | | Organometallic | ZB-125 | — | — | — | — | — | — |
| | | Compound | TC-400 | — | — | — | — | — | — |

| | | | | | | | |
|---|---|---|---|---|---|---|---|
| Polyamine Polymer | POLYMENT SK-1000 | — | — | — | — | — | — |

| | | | | | | Examples | | | | | |
|---|---|---|---|---|---|---|---|---|---|---|---|
| | | | | | | Ex. | Ex. | Ex. | Ex. | Ex. | Ex. |
| | | | | | | 7 | 8 | 9 | 10 | 11 | 12 |
| Blending | Copolymer | Monomer | Alkyl(meth)- | Butyl Acrylate | | 100 | 100 | 100 | 100 | 100 | 100 |
| Formulation | | Component | acrylate | | | | | | | | |
| of Aqueous | | | Carboxyl Group- | Acrylic Acid | | 5 | 5 | 5 | 5 | 5 | 5 |
| Dispersion | | | Containing Vinyl | | | | | | | | |
| Adhesive | | | Monomer | | | | | | | | |
| Composition | | | Phosphoric Acid | PAM-200 | | 2 | 2 | 2 | 2 | 2 | 2 |
| | | | Group-Containing | | | | | | | | |
| | | | Vinyl Monomer | | | | | | | | |
| | | | Alkoxysilyl | KBM-503 | | 0.01 | 0.01 | 0.01 | 0.01 | 0.01 | 0.01 |
| | | | Group-Containing | | | | | | | | |
| | | | Vinyl Monomer | | | | | | | | |
| | Solid Content in Emulsion (Copolymer) | | | | | 100 | 100 | 100 | 100 | 100 | 100 |
| | Aqueous | Clay | Lucentite | per 100 | Clay | 4 | 4 | 4 | 4 | 0.8 | B |
| | Dispersion | Mineral | SPN | Parts of | Mineral | | | | | | |
| | of Clay | (Smectite) | (Hydrophobic- | Copolymer | (Clay | | | | | | |
| | Mineral | | treated) | | Constituent) | | | | | | |
| | | | | | Organic | 6 | 6 | 6 | 6 | 1.2 | 12 |
| | | | | | Componant | | | | | | |
| | | | | | (Cationic | | | | | | |
| | | | | | Dispersing | | | | | | |
| | | | | | Agent) | | | | | | |

| | Kunipia F (Not | per 100 | — | — | — | — | — | — |
|---|---|---|---|---|---|---|---|---|
| | hydrophobic- | Parts of | | | | | | |
| | treated) | Copolymer | | | | | | |
| (Anionic) | Type (phosphate/polycarboxylate) | | Na- | Na- | Na- | Na- | Na- | Na- |
| Dispersing | | | HMP | HMP | HMP | HMP | HMP | HMP |
| Agent | Content of Carboxyl Anion [mmol/g] | | — | — | — | — | — | — |
| | Amount | per 100 Parts | 0.5 | 0.5 | 0.5 | 0.5 | 0.5 | 0.5 |
| | | of Copolymer | | | | | | |
| | | per 100 Parts | 12.5 | 12.5 | 12.5 | 12.5 | 62.5 | 6.25 |
| | | of Clay Mineral | | | | | | |

| Coating | Oxazoline Group-Containing Polymer | | EPOCROS WS-700 | 1.9 | 0.25 | 0.25 | 0.25 | 0.25 | 0.25 |
|---|---|---|---|---|---|---|---|---|---|
| Solution | Compound Having a Plurality | | POISE 532A | 0.1 | — | — | — | — | — |
| of Undercoat | of Carboxyl Groups | | | | | | | | |
| Layer *1 | Electrically | Electrically | Denatron PS02RG | 0.25 | — | — | — | — | — |
| | Conductive | Conductive | | | | | | | |
| | Material | Polymer | | | | | | | |
| | | Organometallic | ZB-125 | — | 0.5 | — | — | — | — |
| | | Compound | TC-400 | — | — | 0.5 | — | — | — |

| | | | | | | | |
|---|---|---|---|---|---|---|---|
| Polyamine Polymer | POLYMENT SK-1000 | — | — | — | 0.25 | — | — |

*1 Solid Content in Coating Solution (%)

TABLE 2

| | | | | | | Examples/ | | | | | |
|---|---|---|---|---|---|---|---|---|---|---|---|
| | | | | | | Comparative Examples | | | | | |
| | | | | | | Ex. | Ex. | Ex. | Ex. | Ex. | Ex. |
| | | | | | | 13 | 14 | 15 | 16 | 17 | 18 |
| Binding | Copolymer | Monomer | Alkyl(meth)- | Butyl Acrylate | | 100 | 100 | 100 | 100 | 100 | 100 |
| Formulation | | Component | acrylate | | | | | | | | |
| of Aqueous | | | Carboxyl Group- | Acrylic Acid | | 5 | 5 | 5 | 5 | 5 | 5 |
| Dispersion | | | Containing Vinyl | | | | | | | | |
| Adhesive | | | Monomer | | | | | | | | |
| Composition | | | Phosphoric Acid | PAM-200 | | 2 | 2 | 2 | 2 | 2 | 2 |
| | | | Group-Containing | | | | | | | | |
| | | | Vinyl Monomer | | | | | | | | |
| | | | Alkoxysilyl | KBM-503 | | 0.01 | 0.01 | 0.01 | 0.01 | 0.01 | 0.01 |
| | | | Group-Containing | | | | | | | | |
| | | | Vinyl Monomer | | | | | | | | |
| | Solid Content in Emulsion (Copolymer) | | | | | 100 | 100 | 100 | 100 | 100 | 100 |
| | Aqueous | Clay | Lucentite | per 100 | Clay | — | — | — | — | 4 | 4 |
| | Dispersion | Mineral | SPN | Parts of | Mineral | | | | | | |
| | of Clay | (Smectite) | (Hydrophobic- | Copolymer | (Clay | | | | | | |
| | Mineral | | treated) | | Constituent) | | | | | | |
| | | | | | Organic | — | — | — | — | 6 | 6 |
| | | | | | Component | | | | | | |
| | | | | | (Cationic | | | | | | |
| | | | | | Dispersing | | | | | | |
| | | | | | Agent) | | | | | | |

| | Kunipia F | per 100 | 0.5 | 1.0 | 2.0 | 4.0 | — | — |
|---|---|---|---|---|---|---|---|---|
| | (Not | Parts of | | | | | | |
| | hydrophobic- | Copolymer | | | | | | |
| | treated) | | | | | | | |
| (Anionic) | Type (phosphate/polycarboxylate) | | — | — | — | — | ARON | AQUAL- |
| Dispersing | | | | | | | A-208 | IC |
| Agent | | | | | | | | TL-37 |
| | Content of Carboxyl Anion [mmol/g] | | — | — | — | — | 6.5 | 6.4 |
| | Amount | per 100 Parts | — | — | — | — | 1 | 1 |
| | | of Copolymer | | | | | | |
| | | per 100 Parts | — | — | — | — | 25 | 25 |
| | | of Clay Mineral | | | | | | |

| Coating | Oxazoline Group-Containing Polymer | | EPOCROS WS-700 | 0.25 | 0.25 | 0.25 | 0.25 | 0.25 | 0.25 |
|---|---|---|---|---|---|---|---|---|---|
| Solution of | Compound Having a Plurality | | POISE 532A | — | — | — | — | — | — |
| Undercoat | of Carboxyl Groups | | | | | | | | |
| Layer *1 | Electrically | Electrically | Denatron | — | — | — | — | — | — |
| | Conductive | Conductive | P502RG | | | | | | |
| | Material | Polymer | | | | | | | |
| | | Organometallic | ZB-125 | — | — | — | — | — | — |
| | | Compound | TC-400 | — | — | — | — | — | — |

| | | | | | | | |
|---|---|---|---|---|---|---|---|
| Polyamine Polymer | POLYMENT | — | — | — | — | — | — |
| | SK-1000 | | | | | | |

| | | | | | | Examples/ | | | | |
|---|---|---|---|---|---|---|---|---|---|---|
| | | | | | | Comparative Examples | | | | |
| | | | | | | Ex. | Ex. | Comp. | Comp. | Comp. |
| | | | | | | 19 | 20 | Ex. 1 | Ex. 2 | Ex. 3 |
| Binding | Copolymer | Monomer | Alkyl(meth)- | Butyl Acrylate | | 100 | 100 | 100 | 100 | 100 |
| Formulation | | Component | acrylate | | | | | | | |
| of Aqueous | | | Carboxyl Group- | Acrylic Acid | | 5 | 5 | 5 | 5 | 5 |
| Dispersion | | | Containing | | | | | | | |
| Adhesive | | | Vinyl Monomer | | | | | | | |
| Composition | | | Phosphoric Acid | PAM-200 | | 2 | 2 | — | 2 | 2 |
| | | | Group-Containing | | | | | | | |
| | | | Vinyl Monomer | | | | | | | |
| | | | Alkoxysilyl | KBM-503 | | 0.01 | 0.01 | 0.01 | 0.01 | 0.01 |
| | | | Group-Containing | | | | | | | |
| | | | Vinyl Monomer | | | | | | | |
| | Solid Content in Emulsion (Copolymer) | | | | | 100 | 100 | 100 | 100 | 100 |
| | Aqueous | Clay | Lucentite | per 100 | Clay | 4 | 4 | 4 | — | 12 |
| | Dispersion | Mineral | SPN | Parts of | Mineral | | | | | |
| | of Clay | (Smectite) | (Hydrophobic- | Copolymer | (Clay | | | | | |
| | Mineral | | treated) | | Constituent) | | | | | |
| | | | | | Organic | 6 | 6 | 6 | — | 18 |
| | | | | | Component | | | | | |
| | | | | | (Cationic | | | | | |
| | | | | | Dispersing | | | | | |
| | | | | | Agent) | | | | | |

| | Kunipia F | per 100 | — | — | — | — | — |
|---|---|---|---|---|---|---|---|
| | (Not | Parts of | | | | | |
| | hydrophobic- | Copolymer | | | | | |
| | treated) | | | | | | |
| (Anionic) | Type (phosphate/polycarboxylate) | | SHALLOL | SN- | — | — | Na- |
| Dispersing | | | AN-103P | Disper- | | | HMP |
| Agent | | | | sant | | | |
| | | | | 5034 | | | |
| | Content of CarboxylAnion [mmol/g] | | 7.9 | 7.0 | — | — | — |
| | Amount | per 100 Parts | 1 | 1 | — | — | 0.5 |
| | | of Copolymer | | | | | |
| | | per 100 Parts | 25 | 25 | — | — | 4.17 |
| | | of Clay Mineral | | | | | |

| Coating | Oxazoline Group-Containing Polymer | | EPOCROS WS-700 | 0.25 | 0.25 | 0.25 | 0.25 | 0.25 |
|---|---|---|---|---|---|---|---|---|
| Solution of | Compound Having a Plurality | | POISE 532A | — | — | — | — | — |
| Undercoat | of Carboxyl Groups | | | | | | | |
| Layer *1 | Electrically | Electrically | Dentron | — | — | — | — | — |
| | Conductive | Conductive | P502RG | | | | | |
| | Material | Polymer | | | | | | |
| | | Organometallic | ZB-125 | — | — | — | — | — |
| | | Compound | TC-400 | — | — | — | — | — |

| | | | | | | |
|---|---|---|---|---|---|---|
| Polyamine Polymer | POLYMENT | — | — | — | — | — |
| | SK-1000 | | | | | |

*1 Solid Content in Coating Solution (%)

The abbreviations in Tables 1 and 2 are shown below. PAM-200: Sipomer PAM-200 (mono-[poly(propylene oxide)methacrylate]phosphate ester (average degree of polymerization of propylene oxide: about 5.0), manufactured by Rhodia Nicca, Ltd.

KBM-503:3-methacryloyloxypropyl-trimethoxysilane (manufactured by SHIN-ETSU CHEMICAL CO., LTD.)

Lucentite SPN: Partially hydrophobic-treated smectite manufactured by CO-OP CHEMICAL CO., LTD.)

Kunipia F: Smectite (not hydrophobic-treated, manufactured by Kunimine Industries Co., Ltd.)

EPOCROS WS-700: Oxazoline group-containing acrylic polymer (water-soluble type, solid content: 25%, main chain: acrylic, pH 7 to 9, oxazoline value: 220 g solid/eq., manufactured by Nippon Shokubai Co., Ltd.)

POISE 532A: Acrylic acid/maleic acid copolymer ammonium salt (number average molecular weight: about 10000, manufactured by Kao Corporation)

Denatron P502RG: Polythiophene electrically conductive polymer (manufactured by Nagase ChemteX Corporation)

ZB-125: ORGATIX ZB-125 (zirconium chloride compound, ZrO₂ content ratio: 15%, manufactured by Matsumoto Pharmaceutical Manufacture Co., Ltd.)

TC-400: ORGATIX TC-400 (diisopropoxytitanium bis(triethanolaminato), (C₃H₇O)₂Ti (C₆H₁₄O₃N)₂, Ti content ratio: 8%, manufactured by Matsumoto Pharmaceutical Manufacture Co., Ltd.)

POLYMENT SK-1000: Polyamine polymer (emulsion type, amine hydrogen equivalent: 650 g solid/eq., manufactured by Nippon Shokubai Co., Ltd.)

ARON A-208: Sodium polyacrylate, polycarboxylate dispersing agent, content of carboxyl anion: 6.5 mmol/g, manufactured by Toagosei Co., Ltd.

Na-HMP: Sodium hexametaphosphate, phosphate dispersing agent, manufactured by Kishida Chemical Co., Ltd.

AQUALIC TL-37: Copolymers of sodium acrylate/sodium maleate, polycarboxylate dispersing agent, content of carboxyl anion: 6.4 mmol/g, manufactured by Nippon Shokubai Co., Ltd.

SHALLOL AN-103P: Ammonium polyacrylate, polycarboxylate dispersing agent, content of carboxyl anion: 7.9 mmol/g, manufactured by Dai-Ichi Kogyo Seiyaku Co., Ltd.

SN-Dispersant 5034: Sodium poly(meth)acrylate (polycarboxylate dispersing agent), content of carboxyl anion: 7.0 mmol/g, manufactured by San Nopco Limited

### (Evaluation)

### 1) Haze

The adhesive optical film (adhesive optical film using a thin polarizing film) obtained in each of Examples and Comparative Examples was cut into pieces measuring 50×50 mm, and haze was measured by a haze computer HZ-1 (manufactured by Suga Test Instruments Co., Ltd.). The results are shown in Tables 3 and 4.

### 2) Initial Adhesion Between Adhesive Layer and Optical Film

The adhesive optical film (adhesive optical film using a thin polarizing film) in each of Examples and Comparative Examples was cut into pieces measuring 25×120 mm to obtain a sample. The release film on the sample was removed and a polypropylene porous membrane was applied onto the adhesive surface (the surface of the adhesive layer) of the sample. An adhesive tape (No. 31B, manufactured by Nitto Denko Corporation) was stuck onto the polypropylene porous membrane to reinforce the sample. Thereafter, the sample was allowed to stand in an atmosphere at 23° C./60% RH for 24 hours. Then, using a double-faced tape, an SUS304 steel plate was attached onto the rear surface (the optical-film-side surface) of the adhesive optical film after standing. Using a tensile strength testing machine, the polypropylene porous membrane and the sample were separated from each other in a direction of 180° at a rate of 300 mm/min, and a peeling stress was then measured. After measuring, whether or not any adhesive layer was adhered to the polypropylene porous membrane, that is, the optical film failure was observed. The results are shown in Tables 3 and 4.

### 3) Aging Adhesion Between Adhesive Layer and Optical Film

The adhesive optical film (adhesive optical film using a thin polarizing film) in each of Examples and Comparative Examples was cut into pieces measuring 25×120 mm to obtain a sample. The sample was aged in an atmosphere at 50° C. and an atmosphere at 60° C./90% RH for 7 days. After aging, the release film on the sample was removed and the polypropylene porous membrane was attached onto the adhesive surface (the surface of the adhesive layer) of the sample. After an adhesive tape (No. 31B, manufactured by Nitto Denko Corporation) was stuck onto the polypropylene porous membrane to reinforce the sample, the sample was allowed to stand in an atmosphere at 23° C./60% RH for 1 day. Then, using a double-faced tape, an SUS304 steel plate was attached onto the rear surface (the optical-film-side surface) of the adhesive optical film after standing. Using a tensile strength testing machine, the polypropylene porous membrane and the sample were separated from each other in a direction of 180° at a rate of 300 mm/min, and a peeling stress was then measured. After measuring, whether or not any adhesive layer was adhered to the side of the polypropylene porous membrane, that is, optical film failure was observed. The results are shown in Tables 3 and 4.

### 4) Adhesion and Fixation of Adhesive Optical Film

After each of the two kinds of adhesive optical films (a thin polarizing film and a standard polarizing film) in each of Examples and Comparative Examples was cut into pieces measuring 230×310 mm, the release film was removed and each of the resulting films was attached onto a glass plate 0.7 mm in thickness (Corning #1737, manufactured by Corning, Inc.). After allowed to stand in an autoclave at 50° C. under 0.5 MPa for 15 minutes, the films were heated in an atmosphere at 90° C. and an atmosphere at 60° C./90% RH for 500 hours to observe peeling of the adhesive optical film visually. The results are shown in Tables 3 and 4.

The presence of peeling of the adhesive optical film was evaluated according to the following criteria.

A: Change such as peeling was not observed.

B: Peeling in size of less than 0.5 mm was observed at the end of the adhesive optical film.

C: Peeling in size of 0.5 mm or more and less than 1 mm was observed at the end of the adhesive optical film.

D: Peeling in size of 1 mm or more was observed at the end of the adhesive optical film.

### 5) Surface Resistance of Optical Film

In each of Examples and Comparative Examples, the optical film on which only an undercoat layer (a thin polarizing film, that is an adhesive type thin polarizing film before an adhesive layer is formed) was provided was allowed to stand in an atmosphere at 23° C./60% RH. Then, the surface resistance of the surface on which the undercoat layer of the optical film was formed was measured in an atmosphere at 23° C./60% RH, using a USR probe with a resistivity meter (Hiresta-Up MCP-HT450, manufactured by Dia Instruments Co., Ltd.) 1 minute after a voltage of 500 V was applied. The results are shown in Tables 3 and 4.

TABLE 3

| | | | | Ex. 1 | Ex. 2 | Ex. 3 | Ex. 4 | Ex. 5 | Ex. 6 |
|---|---|---|---|---|---|---|---|---|---|
| Evaluation | Haze [%] | | | 1.1 | 0.8 | 1.0 | 1.1 | 1.1 | 1.1 |
| | Adhesion Between Adhesive Layer | | Initial | 10.4 | 9.5 | 9.1 | 11.5 | 7.2 | 12.1 |
| | and Optical Film [N/25 mm] | | 23° C./60% RH | | | | | | |
| | | | 50° C. × 1 day | 13.5 | 13.2 | 12.8 | 17.9 | 14.6 | 15.5 |
| | | | 60° C./90% | 16.3 | 15.1 | 14.6 | 18.5 | 15.3 | 12.8 |
| | | | RH × 1 day | | | | | | |
| | Adhesion and | Thin Polarizing Film | 90° C./500 hr | A | A | A | A | A | A |
| | Fixation of | [Thickness: 100 μm] | 60° C./90% | | | | | | |
| | Adhesive | | RH × 500 hr | A | A | A | A | A | A |
| | Optical Film | Standard Polarizing Film | 90° C./500 hr | A | A | A | A | A | A |
| | [N/25 mm] | [TAC thickness: 180 μm] | 60° C./90% | A | A | A | A | A | A |
| | | | RH × 500 hr | | | | | | |

| | | | | | | |
|---|---|---|---|---|---|---|
| Surface Resistance [Ω/□] | 1 × 10¹⁴ | 1 × 10¹⁴ | 1 × 10¹⁴ | 1 × 10¹⁴ | 4 × 10⁹ | 5 × 10⁹ |
| | or more | or more | or more | or more | | |

| | | | | | |
|---|---|---|---|---|---|
| Ex. 7 | Ex. 8 | Ex. 9 | Ex. 10 | Ex. 11 | Ex. 12 |

| Evaluation | Haze [%] | | | 1.0 | 1.0 | 1.0 | 1.0 | 0.6 | 1.5 |
|---|---|---|---|---|---|---|---|---|---|
| | Adhesion Between Adhesive Layer | | Initial | 11.2 | 8.0 | 9.0 | 8.2 | 9.0 | 11.3 |
| | and Optical Film [N/25 mm] | | 23° C./60% RH | | | | | | |
| | | | 50° C. × 1 day | 17.2 | 11.0 | 11.5 | 12.6 | 17.8 | 15.5 |
| | | | 60° C./90% | 13.0 | 13.4 | 14.0 | 15.2 | 12.8 | 12.8 |
| | | | RH × 1 day | | | | | | |
| | Adhesion and | Thin Polarizing Film | 90° C./500 hr | A | A | A | A | A | A |
| | Fixation of | [Thickness: 100 μm] | 60° C./90% | | | | | | |
| | Adhesive | | RH × 500 hr | A | A | A | A | A | A |
| | Optical Film | Standard Polarizing Film | 90° C./500 hr | A | A | A | A | A | A |
| | [N/25 mm] | [TAC thickness: 180 μm] | 60° C./90% | A | A | A | A | A | A |
| | | | RH × 500 hr | | | | | | |

| | | | | | | |
|---|---|---|---|---|---|---|
| Surface Resistance [Ω/□] | 6 × 10⁹ | 6 × 10⁹ | 5 × 10⁹ | 1 × 10¹⁴ | 1 × 10¹⁴ | 1 × 10¹⁴ |
| | | | | or more | or more | or more |

TABLE 4

| | | | | Ex. 13 | Ex. 14 | Ex. 15 | Ex. 16 | Ex. 17 | Ex. 18 |
|---|---|---|---|---|---|---|---|---|---|
| Evaluation | Haze [%] | | | 1.0 | 1.2 | 1.4 | 1.6 | 1.1 | 1.1 |
| | Adhesion Between Adhesive Layer | | Initial | 26.0 | 28.8 | 27.8 | 28.2 | 11.6 | 11.4 |
| | and Optical Film [N/25 mm] | | 23° C./60% RH | | | | | | |
| | | | 50° C. × 1 day | Optical Film Failure | | | | 15.3 | 14.9 |
| | | | 60° C./90% | 24.5 | 27.5 | 31.0 | 29.3 | 16.4 | 16.3 |
| | | | RH × 1 day | | | | | | |
| | Adhesion and | Thin Polarizing Film | 90° C./500 hr | A | A | A | A | A | A |
| | Fixation of | [Thickness: 100 μm] | 60° C./90% | | | | | | |
| | Adhesive | | RH × 500 hr | A | A | A | A | A | A |
| | Optical Film | Standard Polarizing Film | 90° C./500 hr | A | A | A | A | A | A |
| | [N/25 mm] | [TAC thickness: 180 μm] | 60° C./90% | A | A | A | A | A | A |
| | | | RH × 500 hr | | | | | | |

| | | | | | | |
|---|---|---|---|---|---|---|
| Surface Resistance [Ω/□] | 1 × 10¹⁴ | 1 × 10¹⁴ | 1 × 10¹⁴ | 1 × 10¹⁴ | 1 × 10¹⁴ | 1 × 10¹⁴ |
| | or more | or more | or more | or more | or more | or more |

| | | | | | | Comp. | Comp. | Comp. |
|---|---|---|---|---|---|---|---|---|
| | | | | Ex. 19 | Ex. 20 | Ex. 1 | Ex. 2 | Ex. 3 |
| Evaluation | Haze [%] | | | 1.1 | 1.1 | 1.0 | 0.6 | 2.2 |
| | Adhesion Between Adhesive Layer | | Initial | 12.3 | 12.0 | 9.2 | 9.1 | 9.3 |
| | and Optical Film [N/25 mm] | | 23° C./60% RH | | | | | |
| | | | 50° C. × 1 day | 17.8 | 17.1 | 13.3 | 14.0 | 11.0 |
| | | | 60° C./90% | 18.4 | 17.9 | 15.0 | 15.2 | 11.5 |
| | | | RH × 1 day | | | | | |
| | Adhesion and | Thin Polarizing Film | 90° C./500 hr | A | A | A | A | A |
| | Fixation of | [Thickness: 100 μm] | 60° C./90% | | | | | |
| | Adhesive | | RH × 500 hr | A | A | A | A | A |
| | Optical Film | Standard Polarizing Film | 90° C./500 hr | A | A | A | D | A |
| | [N/25 mm] | [TAC thickness: 180 μm] | 60° C./90% | A | A | B | A | A |
| | | | RH × 500 hr | | | | | |

| | | | | | |
|---|---|---|---|---|---|
| Surface Resistance [Ω/□] | 1 × 10¹⁴ | 1 × 10¹⁴ | 1 × 10¹⁴ | 1 × 10¹⁴ | 1 × 10¹⁴ |
| | or more | or more | or more | or more | or more |

While the illustrative embodiments of the present invention are provided in the above description, such is for illustrative purpose only and it is not to be construed limitative. Modification and variation of the present invention which will be obvious to those skilled in the art is to be covered by the following claims.

What is claimed is:

1. An adhesive composition comprising:
a copolymer obtained by preparing a monomer component comprising an alkyl(meth)acrylate whose alkyl group has 4 to 18 carbon atoms, a carboxyl group-containing vinyl monomer and a phosphoric acid group-containing vinyl monomer as essential components, and comprising, as an optional component, a copolymerizable vinyl monomer which is copolymerizable with the essential components so that an amount of the alkyl(meth)acrylate is from 60 to 99 parts by weight per 100 parts by weight of the monomer component, a total amount of the carboxyl group-containing vinyl monomer, the phosphoric acid group-containing vinyl monomer and the copolymerizable vinyl monomer is from 1 to 40 parts by weight per 100 parts by weight of the monomer component, a carboxyl group concentration is from 0.05 to 1.50 mmol/g and a phosphoric acid group concentration is from 0.01 to 0.45 mmol/g in the monomer component, and polymerizing the monomer component; and
a clay mineral
so that an amount of the clay mineral is from 0.5 to 10 parts by weight per 100 parts by weight of the copolymer.

2. The adhesive composition according to claim 1, further comprising a phosphate dispersing agent in an amount from 0.1 to 5 parts by weight and/or a polycarboxylate dispersing agent in an amount from 0.1 to 5 parts by weight per 100 parts by weight of the copolymer.

3. The adhesive composition according to claim 1, wherein an amount of the carboxyl group-containing vinyl monomer is from 0.5 to 15 parts by weight, an amount of the phosphoric acid group-containing vinyl monomer is from 0.5 to 20 parts by weight, and an amount of the copolymerizable vinyl monomer is 39 parts by weight or less per 100 parts by weight of the monomer component.

4. The adhesive composition according to claim 1, comprising, as the copolymerizable vinyl monomer, an alkoxysilyl group-containing vinyl monomer in an amount from 0.001 to 1 part by weight per 100 parts by weight of the monomer component.

5. The adhesive composition according to claim 1, wherein the adhesive composition is an aqueous dispersion.

6. The adhesive composition according to claim 1, wherein the clay mineral is a smectite.

7. The adhesive composition according to claim 1, wherein the clay mineral comprises an organized clay mineral.

8. The adhesive composition according to claim 7, wherein the organized clay mineral is organized by an organic cation having a hydrophilic functional group.

9. The adhesive composition according to claim 8, wherein the organic cation having the hydrophilic functional group is a quaternary ammonium salt having a hydroxyl group.

10. The adhesive composition according to claim 2, obtained by mixing an aqueous dispersion which is obtained by dispersing the clay mineral in water, and an aqueous dispersion of the copolymer in water having the phosphate dispersing agent and/or the polycarboxylate dispersing agent mixed therein.

11. An adhesive optical film comprising:
an optical film;
an adhesive layer laminated on at least one side of the optical film; and
an undercoat-layer interposed between the optical film and the adhesive layer,
the adhesive layer is made of an adhesive composition comprising:
a copolymer obtained by preparing a monomer component comprising an alkyl(meth)acrylate whose alkyl group has 4 to 18 carbon atoms, a carboxyl group-containing vinyl monomer and a phosphoric acid group-containing vinyl monomer as essential components, and comprising, as an optional component, a copolymerizable vinyl monomer which is copolymerizable with the essential components so that an amount of the alkyl(meth)acrylate is from 60 to 99 parts by weight per 100 parts by weight of the monomer component, a total amount of the carboxyl group-containing vinyl monomer, the phosphoric acid group-containing vinyl monomer and the copolymerizable vinyl monomer is from 1 to 40 parts by weight per 100 parts by weight of the monomer component, a carboxyl group concentration is from 0.05 to 1.50 mmol/g and a phosphoric acid group concentration is from 0.01 to 0.45 mmol/g in the monomer component, and polymerizing the monomer component; and
a clay mineral
so that an amount of the clay mineral is from 0.5 to 10 parts by weight per 100 parts by weight of the copolymer.

12. The adhesive optical film according to claim 11, wherein the undercoat layer comprises an oxazoline group-containing polymer.

13. The adhesive optical film according to claim 11, wherein the undercoat layer comprises a water-soluble or aqueous dispersion electrically conductive material.

14. The adhesive optical film according to claim 11, wherein the undercoat layer comprises a mixture of an oxazoline group-containing polymer and a compound having a plurality of carboxyl groups.

15. The adhesive optical film according to claim 11, wherein the undercoat layer comprises a mixture of an oxazoline group-containing polymer and a water-soluble or aqueous dispersion electrically conductive material.

16. The adhesive optical film according to claim 11, wherein the undercoat layer comprises a mixture of an oxazoline group-containing polymer and a polyamine polymer.

17. The adhesive optical film according to claim 11, wherein the undercoat layer comprises a mixture of an oxazoline group-containing polymer, a compound having a plurality of carboxyl groups and a water-soluble or aqueous dispersion electrically conductive material.

18. The adhesive optical film according to claim 13, wherein the water-soluble or aqueous dispersion electrically conductive material is an electrically conductive polymer.

19. The adhesive optical film according to claim 15, wherein the water-soluble or aqueous dispersion electrically conductive material is an electrically conductive polymer.

20. The adhesive optical film according to claim 17, wherein the water-soluble or aqueous dispersion electrically conductive material is an electrically conductive polymer.

21. The adhesive optical film according to claim 18, wherein the electrically conductive polymer is polyaniline and/or polythiophene.

22. The adhesive optical film according to claim 19, wherein the electrically conductive polymer is polyaniline and/or polythiophene.

23. The adhesive optical film according to claim 20, wherein the electrically conductive polymer is polyaniline and/or polythiophene.

24. The adhesive optical film according to claim 13, wherein the water-soluble or aqueous dispersion electrically conductive material is an organometallic compound.

25. The adhesive optical film according to claim 15, wherein the water-soluble or aqueous dispersion electrically conductive material is an organometallic compound.

26. The adhesive optical film according to claim 17, wherein the water-soluble or aqueous dispersion electrically conductive material is an organometallic compound.

27. The adhesive optical film according to claim 24, wherein the organometallic compound is at least one compound selected from the group consisting of an organic zirconium compound, an organic titanium compound and an organic aluminium compound.

28. The adhesive optical film according to claim 25, wherein the organometallic compound is at least one compound selected from the group consisting of an organic zirconium compound, an organic titanium compound and an organic aluminium compound.

29. The adhesive optical film according to claim 26, wherein the organometallic compound is at least one compound selected from the group consisting of an organic zirconium compound, an organic titanium compound and an organic aluminium compound.

30. An image display device using at least one adhesive optical film comprising:
an optical film;
an adhesive layer laminated on at least one side of the optical film; and
an undercoat layer interposed between the optical film and the adhesive layer,
the adhesive layer is made of an adhesive composition comprising:
a copolymer obtained by preparing a monomer component comprising an alkyl(meth)acrylate whose alkyl group has 4 to 18 carbon atoms, a carboxyl group-containing vinyl monomer and a phosphoric acid group-containing vinyl monomer as essential components, and comprising, as an optional component, a copolymerizable vinyl monomer which is copolymerizable with the essential components so that an amount of the alkyl(meth)acrylate is from 60 to 99 parts by weight per 100 parts by weight of the monomer component, a total amount of the carboxyl group-containing vinyl monomer, the phosphoric acid group-containing vinyl monomer and the copolymerizable vinyl monomer is from 1 to 40 parts by weight per 100 parts by weight of the monomer component, a carboxyl group concentration is from 0.05 to 1.50 mmol/g and a phosphoric acid group concentration is from 0.01 to 0.45 mmol/g in the monomer component, and polymerizing the monomer component; and
a clay mineral
so that an amount of the clay mineral is from 0.5 to 10 parts by weight per 100 parts by weight of the copolymer.
